(19) United States
(12) Patent Application Publication
(10) Pub. No.: US 2020/0213053 A1
(43) Pub. Date: Jul. 2, 2020

(54) PRECODING AND MULTI-LAYER TRANSMISSION USING REFERENCE SIGNAL RESOURCE SUBSETS

(71) Applicants: Robert Mark HARRISON, Grapevine, TX (US); Sebastian FAXÉR, Järfälla (SE); Andreas NILSSON, Göteborg (SE); TELEFONAKTIEBOLAGET LM ERICSSON (PUBL), Stockholm (SE)

(72) Inventors: Sebastian FAXÉR, JÄRFÄLLA (SE); Robert Mark HARRISON, GRAPEVINE, TX (US); Andreas NILSSON, GÖTEBORG (SE)

(21) Appl. No.: 16/646,007

(22) PCT Filed: Sep. 11, 2018
(86) PCT No.: PCT/IB2018/056942

§ 371 Date: Mar. 10, 2020

Related U.S. Application Data
(60) Provisional application No. 62/557,022, filed on Sep. 11, 2017.

(51) Int. Cl. H04L 5/00; H04B 7/0456

(52) U.S. Cl. CPC H04L 5/0048; H04B 7/0456; H04L 5/0023

(57) ABSTRACT

A method performed by a transmitting device is provided. The method includes at least one of: receiving an indication of an aggregation of N reference signal (RS) resources, the N RS resources each comprising a number of RS ports P1 and being selected from a group of M RS resources, N being at least 1, and M being at least 2, Determining a number of RS ports, P2, as a number of RS ports in the aggregation of RS resources, according to the indication of the aggregation of N RS resources, where P2 is greater than or equal to P1, receiving an indication of a precoder to be applied to a physical channel, optionally, the precoder being for use in a P2 port transmission of the physical channel; and transmitting the physical channel using the indicated precoder. Other methods, apparatuses, computer programs are provided.

### TECHNICAL FIELD

Disclosed are embodiments for precoding and multi-layer transmission.

### BACKGROUND

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

In RAN1#90, the following agreements were reached on codebook based uplink MIMO:
For DFT-S-OFDM, use rank 1 precoders from table below for 2 Tx with wideband TPMI only
Note: in the following table “codebook index” should be called “TPMI index”

| Codebook | Number of layers ∪ | |
|---|---|---|
| index | 1 | 2 |
| 0 | $\frac{1}{\sqrt{2}} [ \begin{matrix}1 \\ 1\end{matrix} ]$ | $\frac{1}{\sqrt{2}} [ \begin{matrix}1 & 1 \\ 1 & - 1\end{matrix} ]$ |
| 1 | $\frac{1}{\sqrt{2}} [ \begin{matrix}1 \\ - 1\end{matrix} ]$ | $\frac{1}{\sqrt{2}} [ \begin{matrix}1 & 1 & \\ j & - 1 & - j\end{matrix} ]$ |
| 2 | $\frac{1}{\sqrt{2}} [ \begin{matrix}1 \\ j\end{matrix} ]$ | $\frac{1}{\sqrt{2}} [ \begin{matrix}10 \\ 01\end{matrix} ]$ |
| 3 | $\frac{1}{\sqrt{2}} [ \begin{matrix}1 \\ - j\end{matrix} ]$ | |
| 4 | $\frac{1}{\sqrt{2}} [ \begin{matrix}0 \\ 1\end{matrix} ]$ | |
| 5 | $\frac{1}{\sqrt{2}} [ \begin{matrix}0 \\ 1\end{matrix} ]$ | |

For CP-OFDM
At least TPMI indices 0-3 for rank 1 and TPMI indices 0 and 1 for rank 2 are used
One of the two following Antenna port selection mechanisms is supported;
Decide among the two alternatives in RAN1#90bis
Alt 1: TPMI indices 4 and 5 for rank 1, and 2 for rank 2, from the above table are used for CP-OFDM
Alt 2: SRI indicates selected antenna ports
For 2 Tx, use single stage DCI with a semi-statically configured size to convey TPMI, SRI, TRI in Rel-15
Total combined DCI size of TPMI, TRI, and SRI does not vary with PUSCH resource allocation for single stage DCI
Specify UE capability identifying if UL MIMO capable UE can support coherent transmission across its transmit chains
FFS (for further study): if UE capability identifies if coherent transmission is supported on all of, vs. none of, vs. on a subset, of its transmit chains
FFS: how UL MIMO precoding design takes into account the above capability

There currently exist certain challenge(s), including the design of 4 port UL MIMO codebooks, the amount of TPMI, TRI, and SRI overhead that may be available for UL MIMO, how TPMI, TRI, and SRI can be encoded, the benefit of frequency selective precoding, whether TPMI should be persistent, whether TPMI or SRI should be used for antenna selection, the number of ports and layers UL SU-MIMO and the codebook should be designed for, as well as support for non-coherent transmission through the use of multiple SRI and/or TPMI.

### SUMMARY

Certain aspects of the present disclosure and their embodiments may provide solutions to some of the identified challenges or other challenges.

There are, proposed herein, various embodiments which address one or more of the challenges disclosed herein. Methods, apparatuses and system to jointly encode TPMI with SRS resource selection using multiple SRIs but using a fixed field size are disclosed. In some embodiments, the number of ports in the aggregated resource indicated by the multiple SRI varies. Similarly, the number of SRS resources that are selected can also vary, in some embodiments.

According to an embodiment of a first aspect, a method of determining antenna ports and precoding to be used in transmission is disclosed. The method includes one or more of: receiving an indication of an aggregation of N reference signal (RS) resources, the N RS resources each comprising a number of RS ports P1 and being selected from a group of M RS resources, N being at least 1, and M being at least 2, determining a number of RS ports, P2, as a number of RS ports in the aggregation of RS resources, according to the indication of the aggregation of N RS resources, where P2 is greater than or equal to P1, receiving an indication of a precoder to be applied to a physical channel, optionally, the precoder being for use in a P2 port transmission of the physical channel, and transmitting the physical channel using the indicated precoder.

According to a further embodiment, for joint encoding of SRI and TPMI, the method of further includes one or more of determining the precoder and at least one of P2 and N from a single field in a control channel, the the field comprising a predetermined number of bits, wherein the predetermined number of bits does not vary with the indicated precoder, nor does it vary if the indicated values of P2 or N vary.

According to another embodiment, for joint encoding of SRI, TPMI, and TRI, the method further includes one or more of determining a number of MIMO layers with which to transmit the physical channel using the field; and transmitting the physical channel using the number of MIMO layers as well as the indicated precoder.

According to a second aspect, use of a default precoding matrix for non-coherent multi-layer transmission using multiple SRI is provided.

According to an embodiment of a second aspect, a method in a transmitting device of transmitting multiple layers using an aggregation of reference signal (RS) resources, is provided. The method includes one or more of: Indicating by the transmitting device that the device is not capable of coherent transmission on one or more antenna ports, receiving an indication of an aggregation of N RS resources, the N RS resources each comprising a number of RS ports P1 and being selected from a group of M RS resources, N being at least 1, and M being at least 2, determining a number of RS ports, P2, as a number of RS ports in the aggregation of RS resources, according to the indication of the aggregation of N RS resources, where P2 is greater than or equal to P1, transmitting a physical channel using a plurality of MIMO layers according to a precoding matrix, optionally, the precoding matrix corresponding to P2 RS ports and comprising at most one non zero value in each of the columns and rows of the precoding matrix

According to a further aspect, the method may further include determining the number of layers in the plurality of MIMO layers as one of P2 and a sum of a plurality of rank indications, wherein each rank indication of the sum of rank indications corresponds to each of the N RS resources.

Apparatuses, computer programs and computer media suitable to implement methods as noted above or carry instructions for such methods, are also provided.

Certain embodiments may provide one or more of technical advantage(s), as described above.

### BRIEF DESCRIPTION OF THE DRAWINGS

The accompanying drawings, which are incorporated herein and form part of the specification, illustrate various embodiments.

FIG. 1 illustrates subband vs. wideband precoding for Rel-8 and Non-Constant Modulus Codebooks according to some embodiments.

FIG. 2 illustrates Rel-8 vs. Non-Constant Modulus Codebook with 4 Ports in accordance with some embodiments.

FIGS. 3-5 illustrate simulations on performance of additional codebook configurations and at higher ranks.

FIG. 6 illustrates a wireless network in accordance with some embodiments.

FIG. 7 is a block diagram of a user equipment in accordance with some embodiments.

FIG. 8 illustrates a virtualization environment in accordance with some embodiments.

FIG. 9 illustrates a telecommunication network connected via an intermediate network to a host computer in accordance with some embodiments

FIG. 10 illustrates a host computer communicating via a base station with a user equipment over a partially wireless connection in accordance with some embodiments

FIG. 11 is a flowchart illustrating a method implemented in a communication system including a host computer, a base station and a user equipment in accordance with some embodiments.

FIG. 12 is a flowchart illustrating a method implemented in a communication system including a host computer, a base station and a user equipment in accordance with some embodiments

FIG. 13 is a flowchart illustrating a method implemented in a communication system including a host computer, a base station and a user equipment in accordance with some embodiments.

FIG. 14 is a flowchart illustrating a method implemented in a communication system including a host computer, a base station and a user equipment in accordance with some embodiments.

FIG. 15 is a flowchart of method in accordance with particular embodiments of a first aspect, determining antenna ports and precoding to be used in transmission in accordance with some embodiments.

FIG. 16 is a flowchart of a method in accordance with particular embodiments of the second aspect, of transmitting multiple layers using an aggregation of reference signal (RS) resources in accordance with some embodiments.

FIG. 17 illustrates a schematic block diagram of an apparatus in a wireless network in accordance with some embodiments.

FIG. 18 illustrates a schematic block diagram of an apparatus in a wireless network in accordance with some embodiments.

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein. Rather, these embodiments are provided by way of example to convey the scope of the subject matter to those skilled in the art.

In this disclosure, a variety of UL MIMO codebook issues are addressed, including the design of 4 port UL MIMO codebooks, the amount of TPMI, TRI, and SRI overhead that may be available for UL MIMO, how TPMI, TRI, and SRI can be encoded, the benefit of frequency selective precoding, whether TPMI should be persistent, whether TPMI or SRI should be used for antenna selection, the number of ports and layers UL SU-MIMO and the codebook should be designed for, as well as support for non-coherent transmission through the use of multiple SRI and/or TPMI. Link level simulation results investigating the gains of the various precoding designs are given.

Wideband and Frequency Selective TPMI

An important driver for TPMI overhead is whether wideband or frequency selective TPMI is supported. While wideband TPMI has been agreed for DFT-S-OFDM with 2 Tx ports, it is an issue for other configurations, there is no clear understanding in RAN1 of how much TPMI overhead can be used, and the support for wideband vs. subband TPMI is an aspect to resolve. Herein, it is first examined what TPMI overhead might be reasonably carried in PDCCH and then consider upper bounds on what gain might be possible from frequency selective precoding.

TPMI Overhead Limitations

Signaling to support codebook based frequency selective precoding on uplink and downlink are different. In the downlink, TPMI signaling can be avoided, since the UE can determine the effective channel by measuring DMRS. However, in codebook based UL MIMO, the UE must be aware of the precoding desired by the gNB, and so must be signaled with TPMI.

A second difference between uplink and downlink precoding is that UCI payloads can be a wide variety of sizes, while a UE is configured for only a small number of DCI formats with fixed sizes. Therefore, PMI for DL MIMO can have a wide variety of sizes, while TPMI for UL MIMO should preferably have a fixed size. It is noted that two stage DCI signaling is possible to carry additional overhead, but such two stage designs would significantly complicate NR control signaling in general, and seems not preferred in at least a first version of NR. Furthermore, two stage DCI has been deferred until single stage DCI is complete, and so it seems unlikely at this late stage that two stage DCI will be specified in Rel-15.

Another observation is that NR PDCCH should have the same coverage as LTE PDCCH, and therefore the format sizes should be similar. This can be used as a rough guide for TPMI sizes for NR UL MIMO. It is noted that up to 6 bits are used for 4 Tx precoding and rank indication and that 5 bits are used for MCS of a second transport block, with 1 bit for a new data indicator. Therefore, a total of 12 bits for all of TPMI, SRI, and TRI would have a consistent amount of overhead relative to LTE with respect to UL MIMO operation.

Observation: Roughly 10 DCI bits for all of TPMI, SRI, and TRI can be used as a starting point for NR UL MIMO codebook design

Performance of Wideband and Subband TPMI

The number of bits needed for frequency selective TPMI tends to be proportionate to the number of subbands. Link level simulation results comparing the gains of subband TPMI-based transmission to that using wideband transmission are presented. The performance of the Rel-8 two port codebook an example codebook with non-constant modulus elements are shown. Rank 1 precoding is used, since this is where the greatest precoding gains tend to be, and so can evaluate the maximum merit of subband TPMI. A CDL-A channel with 300 ns delay spread was used, with a 20 MHz carrier at 3.5 GHz. MCS 1 from the CQI table (rate 0.074 QPSK) is used as an example. Additional simulation details are given herein. As link level simulations are used, system level considerations such as inter-UE interference are not captured in the performance comparison. Ideal channel estimation is used. Consequently, the results can be considered as upper bounds on the gains of frequency selective precoding when used with realistic codebook structures.

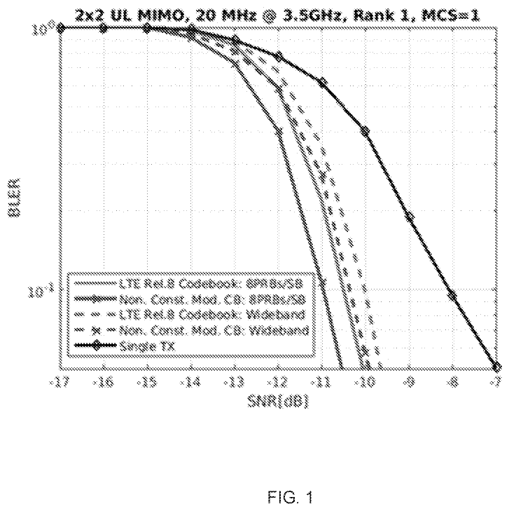

The results are shown in FIG. 1. About 1.9 and 2.3 dB gain at 10% BLER for the Rel-8 and non-constant modulation codebooks respectively, are observed, when a single wideband precoder is used. When subband precoding is used, the gains rise to 2.4 and 2.9 dB, respectively, for the Rel-8 and non-constant modulus codebooks. Therefore, the gain from non-constant modulation is relatively constant at 0.5-0.6 dB regardless of whether wideband or subband precoding is used. Furthermore, even with extremely heavy subband precoding using 13 subbands in 20 MHz and 26 bits TPMI, it is found that subband precoding with constant modulus precoding performs within 0.1 dB of wideband constant modulus precoding requiring 4 bits. It is also noted that this is consistent with prior results using idealized SNR comparisons in system level models of both a single panel array at 2 GHz (see R1-1708669, “UL MIMO procedures for codebook based transmission”, Ericsson, 3GPP TSG RAN WG1 Meeting #89, Hangzhou, P. R. China, May 15-19, 2017 publicly available at www.3gpp.org) and a multi-panel array at 28 GHz (see R1-1711008, “UL MIMO procedures for codebook based transmission”, Ericsson, 3GPP TSG RAN WG1 NR adhoc #2, Qingdao, P. R. China, Jun. 27-30, 2017, publicly available at www.3gpp.org), where the gains from frequency selective constant modulus precoding were essentially the same as those from wideband non-constant modulus precoding.

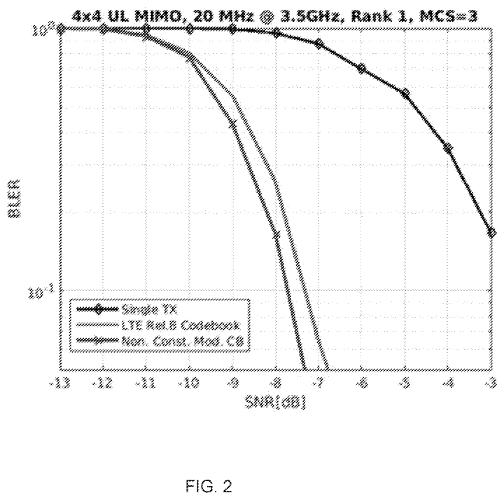

Additional results for 4 port operation and with 8 PRBs per subband are shown in FIG. 2. The remaining simulation conditions are the same as for FIG. 1. More than 4 dB gain for both the Rel-8 and non-constant modulus codebooks, and about 0.4 dB gain from non-constant operation is observed. Therefore, the use of non-constant modulus operation is helpful when 4 ports are used, as well as for 2 port.

Observation: Gains from subband TPMI with practical numbers of bits in realistic channels may be modest. Link level simulations in 20 MHz at 3.5 GHz show that a wideband 4 bit codebook can provide nearly identical performance to subband reporting with 26 bits. The same observations have been made for ideal codebooks at 2 GHz (R1-1708669, “UL MIMO procedures for codebook based transmission”, Ericsson, 3GPP TSG RAN WVG1 Meeting #89, Hangzhou, P. R. China, May 15-19, 2017) as well as multi-panel operation at 28 GHz (R1-1711008, “UL MIMO procedures for codebook based transmission”, Ericsson, 3GPP TSG RAN WVG1 NR adhoc #2, Qingdao, P. R. China, Jun. 27-30, 2017).

According to some embodiments, the following is proposed:

Proposals: 1) Whether subband TPMI is needed is FFS (for further study).

2) Non-constant modulus transmission in codebook based operation is considered as an alternative to subband TPMI for UL MIMO

UL Codebook Structure

General Considerations and Number of SRS Ports

A number of optimizations are possible for UL codebook design. Since both DFT-S-OFDM and CP-OFDM are to be supported for the uplink, one could design codebooks for both sets of waveforms. Multi-stage or single stage codebooks could be supported according to channel conditions and the amount of UL overhead that can be tolerated. Cubic metric preserving codebooks, or those with non-constant modulus elements could be configured to allow some potential power saving vs. performance tradeoffs, and so on. Therefore, it seems desirable to start with a simple, robust design as a baseline, and to add codebooks one-by-one after their performance gains, complexity benefits, and use cases are established.

Optimizations should keep in mind the use cases of UL MIMO. An important goal of multiple Tx chains in a UE is generally SU-MIMO, since it allows a higher peak rate that an end user can benefit from having. System capacity gains are more likely to be from uplink sectorization and/or MU-MIMO, since gNBs tend to have more (perhaps many more) receive antennas. It does not appear possible to set cell coverage based on multiple Tx antenna ports if multiple Tx antenna ports is a UE capability as well as due to UE implementation considerations and other reasons. Therefore multiple UE antennas do not seem an effective way in general to increase range. In short, it seems desirable for designs to focus on getting as much benefit out of the DCI bits as possible, and using simple schemes.

Observation: A wide variety of codebooks could be designed for CP-OFDM vs. DFT-S-OFDM, CM preserving vs. non-constant modulus, single stage vs. multi-stage, etc.

Proposal: Prioritize the design of a robust, simple, codebook as a baseline, and add other codebooks according to their gain, complexity, and use case.

As discussed above, UL MIMO design is motivated by peak rate. NR requires a peak spectral efficiency of 15 bps/Hz on the uplink, and this can be met with four 64 QAM MIMO layers each with a code rate of 5/8. Therefore, although NR Rel-15 does support 8 SRS and DMRS ports, there does not seem to be a need for 8 SU-MIMO layers nor a codebook to support 8 SRS ports at least in a first release of NR. However, 8 port codebooks can be relatively easily added in later releases since 8 port SRS and DMRS are already defined.

Observation: 4 layer SU-MIMO can meet NR peak spectral efficiency requirements of 15 bps/Hz (see 3GPP TR 38.913 v14.2.0, “Study on Scenarios and Requirements for Next Generation Access Technologies (Release 14)”, March 2017, Publicly available at www.3gpp.org)

Proposal: Rel-15 NR supports at most 4 layers for SU-MIMO transmission and codebooks.

Codebook Structure Alternatives and Performance

The antenna array topology of UEs is expected to be arbitrary to a certain extent with respect of antenna element radiation patters, polarization properties, antenna element separations and pointing directions. For UE implementations, especially at higher frequencies, it is expected that the different antenna arrangements within a UE (where each antenna arrangement, e.g. a single antenna element or a panel, is assumed to be connected to one baseband port) will experience channels with low or no correlation, for example due to radiation patters pointing in different directions, large separation between the antenna arrangements or orthogonal polarizations. This is not to say that simple i.i.d. models are appropriate. Rather, evaluations with realistic channels and models of these various UE configurations are needed to produce a robust codebook.

Hence, it seems desired to create a codebook that can function well in a wide variety of UE antenna configurations and channel conditions. The DL DFT-based codebooks which are based on a uniform linear array of antenna elements or subarrays, with equally spaced antenna elements, may not be sufficient for UEs.

Observation: To support full UE antenna implementation freedom, NR codebook should be designed considering a wide variety of UE antenna configurations and channel conditions.

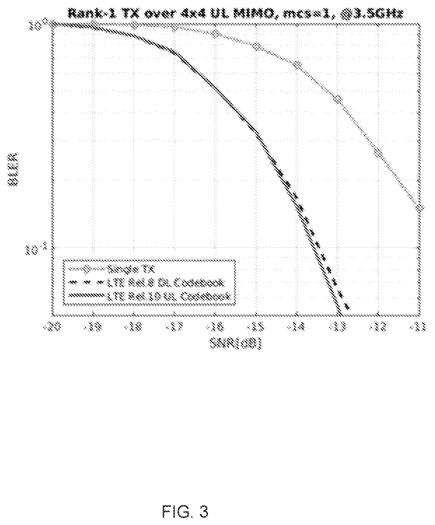

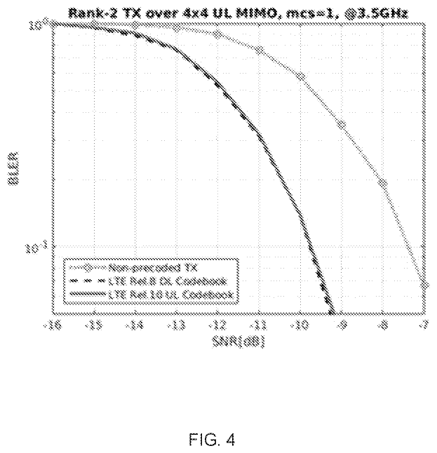

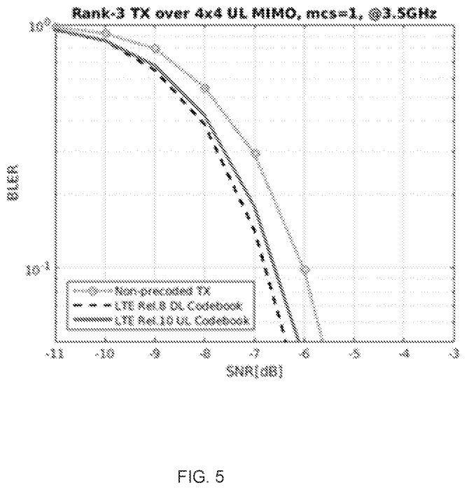

The performance of additional codebook configurations and at higher ranks is compared as illustrated in FIGS. 3-5. Here the Rel-10 4 port UL MIMO codebook and the Rel-8 DL codebook are compared. Single antenna port for rank 1 and non-precoded transmission for ranks 2 and 3 (where the first 2 or 3 ports are used without precoding across the ports, i.e. a 2×2 or 3×3 identity matrix is used) are shown for reference. MCS 1 is used, and the other simulation conditions are the same as those used above. It is observed that the performance of the Rel-10 UL codebook and the Rel-8 DL codebook are close for all ranks, especially for ranks 1 and 2. Given the close performance of the Rel-8 DL and Rel-10 UL codebooks, it appears that it may be difficult to find new constant modulus codebooks with substantial gain over the existing LTE UL codebook. However, as observed above, non-constant modulation can provide some gains.

Observations: Constant modulus codebooks providing substantial gain over the LTE 4 port UL codebook may be difficult to find.

Diagonal Precoding Matrices

One remaining detail of the 2 Tx codebook is if the diagonal precoding matrix for rank 2 (TPMI index ‘2’ for rank 2) is used with TPMI. This matrix is expected to improve performance, especially for dual polarized UE antenna setups under line of sight conditions. A second use for such a diagonal precoding matrix is to support non-coherent transmission, as it can indicate power allocation across layers as well as that the layers are not combined. Noting its use for both 2 and 4 antennas in the LTE UL codebook, and the need for non-coherent transmission on 4 as well as two ports, the diagonal matrix seems equally useful for 4 ports.

Proposal: The following diagonal precoding matrices are included in the 2 port UL MIMO codebook for rank 2 and in the 4 port UL MIMO codebook for rank 4, respectively:

$$2 port rank 2 \text{:} \frac{1}{\sqrt{2}} [ \begin{matrix}1 & 0 \\ 0 & 1\end{matrix} ] , 4 port rank 4 \text{:} \frac{1}{2} [ \begin{matrix}1 & 0 & 0 & 0 \\ 0 & 1 & 0 & 0 \\ 0 & 0 & 1 & 0 \\ 0 & 0 & 0 & 1\end{matrix} ]$$

Non-Coherent Transmission

UE capability supporting non-coherent transmission for NR UL-MIMO was agreed in RAN1#90. However, it was left FFS if UE capability identifies if coherent transmission is supported on all of, vs. none of, vs. on a subset, of its transmit chains. These alternatives are considered further below.

There are 4 possibilities for complete and partial non-coherent transmission:

1. The UE does not support coherent transmission between any SRS ports.

In such a case, the UE transmits a different modulation symbol on each of its transmit chains, and the relative phase of the transmit chains is not adjusted. Therefore, TPMI is not needed, but mechanisms to determine the rank are.

If there is more than one port in the SRS resource(s) indicated by SRI, and TPMI is not indicated, it is still necessary to determine the power transmitted on each layer as well as the rank. One mechanism to determine the power is to define a default diagonal precoding matrix with equal power split across all layers. The total rank can be indicated by a sum of RIs, or simply the sum of one port resources if SRIs indicate one port resources.

2. The UE can transmit coherently between SRS ports in an SRS resource, but not across SRS resources.

An example of this operation could be where a UE has two dual-polarized panels, where each panel corresponds to an SRS resource. The two antenna ports within a panel are calibrated with respect to each other, but the antenna ports corresponding to different panels are not calibrated with respect to each other. In this case, it would be preferred to coherently transmit within a panel (where each panel is corresponding to one SRS resource) and non-coherently transmit between the panels. Therefore, it should be possible for the TRP to perform non-coherent transmission between SRS resources by feeding back multiple TPMIs, where each of the signaled TPMIs corresponds to one indicated SRS resource.

3. The UE can transmit coherently only between subsets of SRS ports in an SRS resource

The two panel setup above could be used, except that one SRS resource is used for both panels. Such a design would require indicating combinations of SRS ports that could be coherently transmitted together, and codebook structures supporting partial coherency would need to be designed. Consequently, this configuration does not seem beneficial to support.

4. The UE cannot coherently transmit within an SRS resource, but can across SRS resources.

This configuration does not seem too useful, since one of the benefits is to select which SRS resources to transmit. Selecting a resource means that it can't be coherently combined.

Proposals: Non-coherent transmission between all SRS ports or between SRS resources is supported

Non-coherent transmission on all ports in the SRS resources signaled by multiple SRI is supported.

Multiple TPMIs can be signaled to allow non-coherent transmission over SRS ports belonging to different SRS resources.

Single Shot Vs. Persistent TPMI

The two alternatives from RAN1#88bis below have implications on whether TPMI is persistent over time.
Alternative 1 (Alt 1): Subband TPMIs are signaled via DCI to the UE only for allocated PRBs for a given PUSCH transmission
Alternative 2 (Alt 2): Subband TPMIs are signaled via DCI to the UE for all PRBs in UL, regardless of the actual RA for a given PUSCH transmission

In Alternative 1, TPMI applies only to a PUSCH transmission. This means that there is no interdependence or accumulation of TPMI between subframes, i.e. TPMI is ‘single shot’. Allowing TPMI to be persistent could be used to reduce overhead, e.g. in multi-stage codebooks where a long term ‘W1’ is signaled less frequently than a short term ‘W2’. Similarly, different TPMIs in different subframes could apply to different subbands. However, if or how much overhead can be saved depends on channel characteristics and how many PUSCH transmissions a UE makes.

Furthermore, TPMI only applies to PUSCH, rather than other signals, such as SRS. This is in contrast to alternative 2, which allows precoded SRS controlled by TPMI, since the TPMIs can apply to all PRBs in UL, not just the PUSCH. Since eNB knows the TPMI, and has either non-precoded SRS or DMRS, eNB should be able to determine the composite channel after precoding, and there is no benefit from e.g. interference estimation or power control perspectives. Furthermore, multiple SRS resources can be used to track the beamforming gain of Tx chains. Consequently, the need for TPMI control of SRS precoding should be further studied.

If Alt 2. is further considered, whether it applies outside of a bandwidth part should be addressed.

Proposal: A variation of Alt 1 from RAN1#88bis is supported for at least wideband TPMI and single stage codebook: TPMI is signaled via DCI to the UE only for allocated PRBs for a given PUSCH transmission

Uses of SRI with TPMI

Since antenna patterns, orientations, and polarization behavior will vary widely in UEs, it is not practical to develop models specifically for multi-panel UEs. However, codebook designs that support uncorrelated elements can provide gains across a wide variety of antenna configurations. Therefore, a sufficiently robust single panel design could be used in the multi panel case.

Observation: Robust single panel designs can be used for multi-panel applications

Proposal: UL codebook design targets single panel operation; multi-panel operation is supported with the single panel design

An approach may be to transmit from different panels on different SRS resources, since spatial characteristics of elements in panels are likely to be different between panels. However, it can also be beneficial to transmit simultaneously on multiple panels to produce a higher rank, a more directive transmission, and/or to combine transmit power from multiple power amplifiers, as discussed in R1-1716369, “UL multi-panel transmission”, Ericsson, 3GPP TSG RAN WVG1 NR adhoc #3, Nagoya, Japan, Sep. 21-28, 2017. Consequently, the ports to which a codebook can apply should be able to be formed by aggregating SRS resources. When multiple SRI(s) are indicated, it should be possible to signal a TPMI that applies across all ports in the indicated SRS resources, and a codebook corresponding to the aggregated resource is used which will result in coherent transmission over the ports in the indicated SRS resources. However, in some cases it might be preferred to perform coherent transmission only over the SRS ports within an SRS resource and non-coherent transmission between SRS ports corresponding to different SRS resources (R1-1716369, “UL multi-panel transmission”, Ericsson, 3GPP TSG RAN WG1 NR adhoc #3, Nagoya, Japan, Sep. 21-28, 2017, publicly available at www.3gpp.org). For example, assume that a UE has two dual-polarized panels, and that the two antenna ports within a panel are calibrated with respect to each other, but the antenna ports corresponding to different panels are not calibrated with respect to each other. In this case, it would be preferred to do coherent transmission within a panel (where each panel is corresponding to one SRS resource) and non-coherent transmission between the panels. Therefore, it should be possible for the TRP to perform non-coherent transmission between SRS resources by feeding back multiple TPMIs, where each of the signaled TPMIs corresponds to one indicated SRS resource.

Proposals: 1) TPMI can apply to aggregated SRS Resources indicated by multiple SRI(s) to allow coherent transmission over SRS ports corresponding to multiple SRS resources; 2) Multiple TPMIs can be signaled to allow non-coherent transmission over SRS ports belonging to different SRS resource.

It was agreed in RAN1#90 that NR will support antenna port selection using either TPMI or SRI. Selection with TPMI can be accomplished by using N port precoding matrices containing fewer than N non-zero entries per column, such as PMIs 4 and 5 in the agreed 2 port codebook from RAN1#90. SRI can select antenna ports by indicating a subset of the SRS resources configured for the UE. These two alternatives are considered below.

For two ports, if SRS selection is used, then two different one port SRS resources are configured. 3 SRI states are possible: the first or second port is used, or both are used. If one port is used, there is no corresponding TPMI state and the TRI is equal to one. If both ports/resources are used, there are 7 matrices using both antenna ports: 4 for rank 1 and 3 for rank 2. Therefore, SRI can be jointly encoded with TPMI/TRI in a total of 9 states and therefore 4 bits. This is identical to when TPMI is used for selection in one 2 port SRS resource. If SRI and TPMI/TRI are not jointly encoded, two bits for SRI and 3 bits for TPMI/TRI would be needed for a total of 5 bits.

For 4 ports, if SRS selection is used, then either two 2 port SRS resources or four 1 port SRS are configured. In the 4 resource case, 1, 2, or 4 ports can be selected. Here, it is presumed a 3 port codebook is not defined as that would take significant specification effort, and since the benefit of such a codebook has not yet been studied. The number of SRI states needed to select 1, 2, or 4 ports from 4 total ports is 4, 6, and 1. If the agreed 2 port codebook without the rank 1 selection vectors and the Rel-10 4 port codebook without its selection vectors is used, then the total number of states for jointly encoded SRI/TMPI/TRI is 91, or 7 bits. It is noted that if SRI is independently encoded from TPMI/TRI in this case 10 bits are needed (4 bits for the 11 SRI states and 6 bits for TPMI/TRI), resulting a 43% increase in overhead for this field.

TABLE 1
SRI, TPMI, and TRI Overhead with SRI Selecting
from 4 one port SRS resources

| # Selected | | TPMI/TRI | TPMI/TRI & |
|---|---|---|---|
| SRS Resources | SRI States | States | SRI States |
| 1 | 4 | 0 | 4 |
| 2 | 6 | 7 | 42 |
| 4 | 1 | 45 | 45 |
| Total | 11 (4 bits) | 52 (6 bits) | 91 (7 bits) |

For the 2 two port resource case, either or both of the resources can be selected, and the same 2 or 4 port codebooks can be used. This results in 59 total states for TPMI/TRI/SRI, or 6 bits. Separate TPMI/TRI and SRI encoding would require 6+2=8 bits, or a 33% overhead increase as compared to joint encoding.

TABLE 2
SRI, TPMI, and TRI Overhead with SRI Selecting
from 2 two port SRS resources

| # Selected | | TPMI/TRI | TPMI/TRI & |
|---|---|---|---|
| SRS Resources | SRI States | States | SRI States |
| 1 | 2 | 7 | 14 |
| 2 | 1 | 45 | 45 |
| Total | 3 (2 bits) | 52 (6 bits) | 59 (6 bits) |

Considering an 8 SRS resource case now with 1, 2, or 4 ports per SRS resource, it is possible to use 9 to 12 bits to jointly encode SRI/TPMI/TRI.

TABLE 3
SRI, TPMI, and TRI Overhead with SRI Selecting from
8 {1, 2, or 4} port SRS resources

| #SRS | | | | |
|---|---|---|---|---|
| Resources × | # Selected | SRI | TPMI/TRI | TPMI/TRI & |
| # SRS ports | SRS Resources | States | States | SRI States |
| 8 × 1 | 1 | 8 | 0 | 8 |
| 8 × 1 | 2 | 28 | 7 | 196 |
| 8 × 1 | 4 | 70 | 45 | 3150 |
| Total | | 106 (7 bits) | 52 (6 bits) | 3354 (12 bits) |
| 8 × 2 | 1 | 8 | 7 | 56 |
| 8 × 2 | 2 | 28 | 45 | 1260 |
| Total | | 36 (6 bits) | 52 (6 bits) | 1316 (11 bits) |
| 8 × 4 | 1 | 8 | 45 | 360 |
| Total | | 8 (3 bits) | 45 (6 bits) | 360 (9 bits) |

For more than 4 ports, it is similarly possible to describe an N port codebook using only TPMI/TRI bits, wherein at most 1, 2, or 4 elements of the codebook are nonzero. However, using an N port codebook when only a subset of the ports are actually used is at best awkward, does not scale with the number of SRS resources/panels, and is not forward compatible if the number of supported SRS resources/panels increases. Which combinations of ports are supported in the codebook would need to be specifically identified, and these will either be a subset of what can be accomplished using SRI(s), or match exactly what SRI(s) can select. Determining the subset of ports selected for the many SRS ports that can be supported with multiple SRI will require substantial design effort and specification work. If the full set of combinations is possible, antenna port selection becomes separable from the codebook design, and is much simpler to express with a fixed set of codebooks without port selection combined with antenna port selection.

Observations:

If SRI, TPMI, and TRI are jointly encoded, the overhead needed for selection if the selection PMIs are within a codebook or if SRI is used for SRS resource selection can be identical.

The overhead is generally larger if they are not jointly encoded, in some cases as much as 43% larger.

Joint encoding of SRI, TPMI, and TRI can be accomplished with 12 bits or less for up to 8 SRS resources

Defining a port selection mechanism on top of multiple SRI signaling is

Redundant specification effort.

The use of multiple SRI has been agreed for non-codebook based and codebook based precoding already.

Not scalable with the number of SRS resources, nor forward compatible

Rather counter intuitive for larger numbers of ports:

Why define an N port codebook when only M<N ports is ever non zero?

Proposals:

SRI selects and/or aggregates ports

Up to 4 SRS ports can be aggregated using all indicated SRI(s)

An aggregation of SRS resources can contain 1, 2, or 4 ports

Precoding matrices for N ports contain at least N non-zero entries

TPMI, TRI, and SRI are jointly encoded

Certain embodiments of this disclosure consider a variety of UL MIMO codebook related topics, including the design of 4 port UL MIMO codebooks, the amount of TPMI, TRI, and SRI overhead that may be available for UL MIMO, how TPMI, TRI, and SRI can be encoded, the benefit of frequency selective precoding, whether TPMI should be persistent, whether TPMI or SRI should be used for antenna selection, the number of ports and layers UL SU-MIMO and the codebook should be designed for, as well as support for non-coherent transmission through the use of multiple SRI and/or TPMI. Link level simulation results investigating the gains of subband precoding, and various codebook designs were presented. Given the results and analysis, the following observations are made:

Observations:

Roughly 10 DCI bits for all of TPMI, SRI, and TRI can be used as a starting point for NR UL MIMO codebook design

Gains from subband TPMI with practical numbers of bits in realistic channels may be modest. Link level simulations in 20 MHz at 3.5 GHz show that a wideband 4 bit codebook can provide nearly identical performance to subband reporting with 26 bits. The same observations have been made for ideal codebooks at 2 GHz 0 as well as multi-panel operation at 28 GHz 0.

A wide variety of codebooks could be designed for CP-OFDM vs. DFT-S-OFDM, CM preserving vs. non-constant modulus, single stage vs. multi-stage, etc.

To support full UE antenna implementation freedom, NR codebook should be designed considering a wide variety of UE antenna configurations and channel conditions.

Robust single panel designs can be used for multi-panel applications

Non-constant modulus codebooks can provide incremental gain over both LTE Rel-8 downlink and Rel-10 uplink codebooks.

Constant modulus codebooks providing substantial gain over the LTE 4 port UL codebook may be difficult to find.

If SRI, TPMI, and TRI are jointly encoded, the overhead needed for selection if the selection PMIs are within a codebook or if SRI is used for SRS resource selection can be identical.

The overhead is generally larger if they are not jointly encoded, in some cases as much as 43% larger.

Joint encoding of SRI, TPMI, and TRI can be accomplished with 12 bits or less for up to 8 SRS resources

Defining a port selection mechanism on top of multiple SRI signaling is

Redundant specification effort.

The use of multiple SRI has been agreed for non-codebook based and codebook based precoding already.

Not scalable with the number of SRS resources, nor forward compatible

Rather counter intuitive for larger numbers of ports:

Why define an N port codebook when only M<N ports is ever non zero?

4 layer SU-MIMO can meet NR peak spectral efficiency requirements of 15 bps/Hz (see 3GPP TR 38.913 v14.2.0, “Study on Scenarios and Requirements for Next Generation Access Technologies (Release 14)”, March 2017, Publicly available at www.3gpp.org)

Therefore, according to certain embodiments, the following proposals are made.

Proposals:

SRI selects and/or aggregates ports

Up to 4 SRS ports can be aggregated using all indicated SRI(s)

An aggregation of SRS resources can contain 1, 2, or 4 ports

Precoding matrices for N ports contain at least N non-zero entries

TPMI can apply to aggregated SRS Resources indicated by multiple SRI(s) to allow coherent transmission over SRS ports corresponding to multiple SRS resources.

Non-coherent transmission between all SRS ports or between SRS resources is supported

Non-coherent transmission on all ports in the SRS resources signaled by multiple SRI is supported.

Multiple TPMIs can be signaled to allow non-coherent transmission over SRS ports belonging to different SRS resources.

TPMI, TRI, and SRI are jointly encoded

The following diagonal precoding matrices are included in the 2 port UL MIMO codebook for rank 2 and in the 4 port UL MIMO codebook for rank 4, respectively:

$$2 port rank 2 \text{:} \frac{1}{\sqrt{2}} [ \begin{matrix}1 & 0 \\ 0 & 1\end{matrix} ] , 4 port rank 4 \text{:} \frac{1}{2} [ \begin{matrix}1 & 0 & 0 & 0 \\ 0 & 1 & 0 & 0 \\ 0 & 0 & 1 & 0 \\ 0 & 0 & 0 & 1\end{matrix} ]$$

Proposals:

Whether subband TPMI is needed is FFS

Non-constant modulus transmission in codebook based operation is considered as an alternative to subband TPMI for UL MIMO

Prioritize the design of a robust, simple, codebook as a baseline, and add other codebooks according to their gain, complexity, and use case.

UL codebook design targets single panel operation; multi-panel operation is supported with the single panel design

A variation of Alt 1 from RAN1#88bis is supported for at least wideband TPMI and single stage codebook: TPMI is signaled via DCI to the UE only for allocated PRBs for a given PUSCH transmission

Rel-15 NR supports at most 4 layers for SU-MIMO transmission and codebooks.

Simulation Parameters

| Parameter | Value | |
|---|---|---|
| Channel Model | TR38900_5G_CDL_A | |
| UE Tx × gNB Rx | 2 × 2, 4 × 4; cross polarized elements | |
| Antennas | | |
| Subcarrier Spacing | 15 | kHz |
| UE speed | 3 | km/h |
| Delay spread | 300 | ns |
| Transmission Slot | 14 | symbols |
| Length | | |

| | |
|---|---|
| Channel estimation | Ideal |
| Link Adaptation | Disabled |

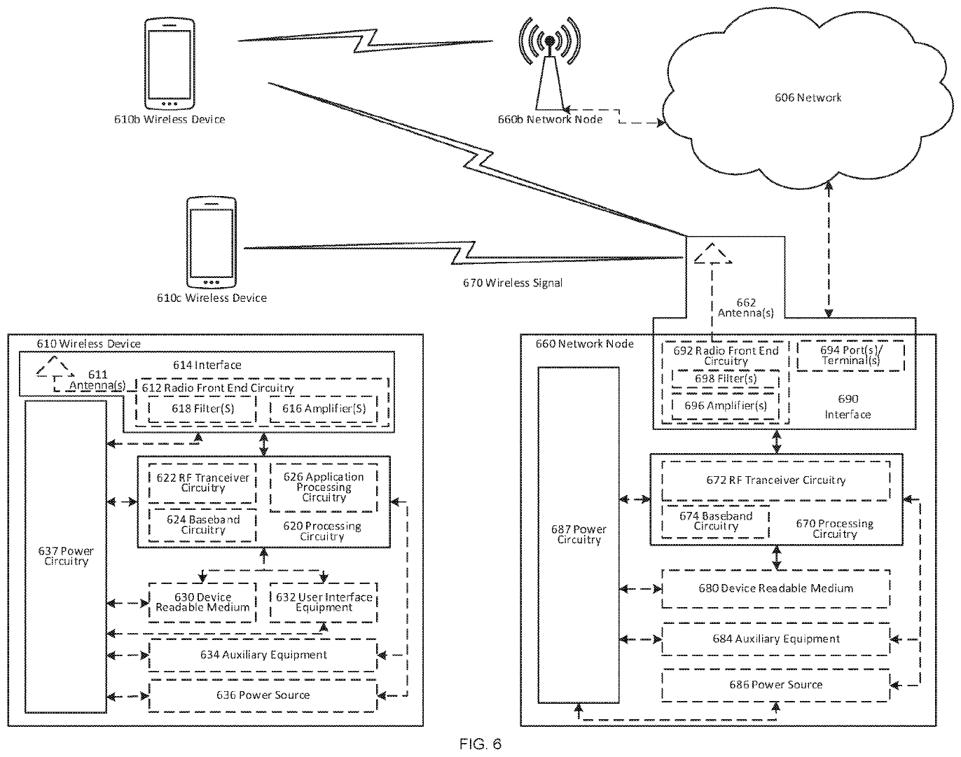

Although the subject matter described herein may be implemented in any appropriate type of system using any suitable components, the embodiments disclosed herein are described in relation to a wireless network, such as the example wireless network illustrated in FIG. 6. For simplicity, the wireless network of FIG. 6 only depicts network 606, network nodes 660 and 660b, and WDs 610, 610b, and 610c. In practice, a wireless network may further include any additional elements suitable to support communication between wireless devices or between a wireless device and another communication device, such as a landline telephone, a service provider, or any other network node or end device. Of the illustrated components, network node 660 and wireless device (WVD) 610 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 606 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 660 and WD 610 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 6, network node 660 includes processing circuitry 670, device readable medium 680, interface 690, auxiliary equipment 684, power source 686, power circuitry 687, and antenna 662. Although network node 660 illustrated in the example wireless network of FIG. 6 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 660 are depicted as single boxes located within a larger box, or nested within multiple boxes, in practice, a network node may comprise multiple different physical components that make up a single illustrated component (e.g., device readable medium 680 may comprise multiple separate hard drives as well as multiple RAM modules).

Similarly, network node 660 may be composed of multiple physically separate components (e.g., a NodeB component and a RNC component, or a BTS component and a BSC component, etc.), which may each have their own respective components. In certain scenarios in which network node 660 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 660 may be configured to support multiple radio access technologies (RATs). In such embodiments, some components may be duplicated (e.g., separate device readable medium 680 for the different RATs) and some components may be reused (e.g., the same antenna 662 may be shared by the RATs). Network node 660 may also include multiple sets of the various illustrated components for different wireless technologies integrated into network node 660, such as, for example, GSM, WCDMA, LTE, NR, WiFi, or Bluetooth wireless technologies. These wireless technologies may be integrated into the same or different chip or set of chips and other components within network node 660.

Processing circuitry 670 is configured to perform any determining, calculating, or similar operations (e.g., certain obtaining operations) described herein as being provided by a network node. These operations performed by processing circuitry 670 may include processing information obtained by processing circuitry 670 by, for example, converting the obtained information into other information, comparing the obtained information or converted information to information stored in the network node, and/or performing one or more operations based on the obtained information or converted information, and as a result of said processing making a determination.

Processing circuitry 670 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 660 components, such as device readable medium 680, network node 660 functionality. For example, processing circuitry 670 may execute instructions stored in device readable medium 680 or in memory within processing circuitry 670. Such functionality may include providing any of the various wireless features, functions, or benefits discussed herein. In some embodiments, processing circuitry 670 may include a system on a chip (SOC).

In some embodiments, processing circuitry 670 may include one or more of radio frequency (RF) transceiver circuitry 672 and baseband processing circuitry 674. In some embodiments, radio frequency (RF) transceiver circuitry 672 and baseband processing circuitry 674 may be on separate chips (or sets of chips), boards, or units, such as radio units and digital units. In alternative embodiments, part or all of RF transceiver circuitry 672 and baseband processing circuitry 674 may be on the same chip or set of chips, boards, or units In certain embodiments, some or all of the functionality described herein as being provided by a network node, base station, eNB or other such network device may be performed by processing circuitry 670 executing instructions stored on device readable medium 680 or memory within processing circuitry 670. In alternative embodiments, some or all of the functionality may be provided by processing circuitry 670 without executing instructions stored on a separate or discrete device readable medium, such as in a hard-wired manner. In any of those embodiments, whether executing instructions stored on a device readable storage medium or not, processing circuitry 670 can be configured to perform the described functionality. The benefits provided by such functionality are not limited to processing circuitry 670 alone or to other components of network node 660, but are enjoyed by network node 660 as a whole, and/or by end users and the wireless network generally.

Device readable medium 680 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 670. Device readable medium 680 may store any suitable instructions, data or information, including a computer program, software, an application including one or more of logic, rules, code, tables, etc. and/or other instructions capable of being executed by processing circuitry 670 and, utilized by network node 660. Device readable medium 680 may be used to store any calculations made by processing circuitry 670 and/or any data received via interface 690. In some embodiments, processing circuitry 670 and device readable medium 680 may be considered to be integrated.

Interface 690 is used in the wired or wireless communication of signalling and/or data between network node 660, network 606, and/or WDs 610. As illustrated, interface 690 comprises port(s)/terminal(s) 694 to send and receive data, for example to and from network 606 over a wired connection. Interface 690 also includes radio front end circuitry 692 that may be coupled to, or in certain embodiments a part of, antenna 662. Radio front end circuitry 692 comprises filters 698 and amplifiers 696. Radio front end circuitry 692 may be connected to antenna 662 and processing circuitry 670. Radio front end circuitry may be configured to condition signals communicated between antenna 662 and processing circuitry 670. Radio front end circuitry 692 may receive digital data that is to be sent out to other network nodes or WDs via a wireless connection. Radio front end circuitry 692 may convert the digital data into a radio signal having the appropriate channel and bandwidth parameters using a combination of filters 698 and/or amplifiers 696. The radio signal may then be transmitted via antenna 662. Similarly, when receiving data, antenna 662 may collect radio signals which are then converted into digital data by radio front end circuitry 692. The digital data may be passed to processing circuitry 670. In other embodiments, the interface may comprise different components and/or different combinations of components.

In certain alternative embodiments, network node 660 may not include separate radio front end circuitry 692, instead, processing circuitry 670 may comprise radio front end circuitry and may be connected to antenna 662 without separate radio front end circuitry 692. Similarly, in some embodiments, all or some of RF transceiver circuitry 672 may be considered a part of interface 690. In still other embodiments, interface 690 may include one or more ports or terminals 694, radio front end circuitry 692, and RF transceiver circuitry 672, as part of a radio unit (not shown), and interface 690 may communicate with baseband processing circuitry 674, which is part of a digital unit (not shown).

Antenna 662 may include one or more antennas, or antenna arrays, configured to send and/or receive wireless signals. Antenna 662 may be coupled to radio front end circuitry 690 and may be any type of antenna capable of transmitting and receiving data and/or signals wirelessly. In some embodiments, antenna 662 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 662 may be separate from network node 660 and may be connectable to network node 660 through an interface or port.

Antenna 662, interface 690, and/or processing circuitry 670 may be configured to perform any receiving operations and/or certain obtaining operations described herein as being performed by a network node. Any information, data and/or signals may be received from a wireless device, another network node and/or any other network equipment. Similarly, antenna 662, interface 690, and/or processing circuitry 670 may be configured to perform any transmitting operations described herein as being performed by a network node. Any information, data and/or signals may be transmitted to a wireless device, another network node and/or any other network equipment.

Power circuitry 687 may comprise, or be coupled to, power management circuitry and is configured to supply the components of network node 660 with power for performing the functionality described herein. Power circuitry 687 may receive power from power source 686. Power source 686 and/or power circuitry 687 may be configured to provide power to the various components of network node 660 in a form suitable for the respective components (e.g., at a voltage and current level needed for each respective component). Power source 686 may either be included in, or external to, power circuitry 687 and/or network node 660. For example, network node 660 may be connectable to an external power source (e.g., an electricity outlet) via an input circuitry or interface such as an electrical cable, whereby the external power source supplies power to power circuitry 687. As a further example, power source 686 may comprise a source of power in the form of a battery or battery pack which is connected to, or integrated in, power circuitry 687. The battery may provide backup power should the external power source fail. Other types of power sources, such as photovoltaic devices, may also be used.

Alternative embodiments of network node 660 may include additional components beyond those shown in FIG. 6 that may be responsible for providing certain aspects of the network node's functionality, including any of the functionality described herein and/or any functionality necessary to support the subject matter described herein. For example, network node 660 may include user interface equipment to allow input of information into network node 660 and to allow output of information from network node 660. This may allow a user to perform diagnostic, maintenance, repair, and other administrative functions for network node 660.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V21), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 610 includes antenna 611, interface 614, processing circuitry 620, device readable medium 630, user interface equipment 632, auxiliary equipment 634, power source 636 and power circuitry 637. WD 610 may include multiple sets of one or more of the illustrated components for different wireless technologies supported by WD 610, such as, for example, GSM, WCDMA, LTE, NR, WiFi, WiMAX, or Bluetooth wireless technologies, just to mention a few. These wireless technologies may be integrated into the same or different chips or set of chips as other components within WD 610.

Antenna 611 may include one or more antennas or antenna arrays, configured to send and/or receive wireless signals, and is connected to interface 614. In certain alternative embodiments, antenna 611 may be separate from WD 610 and be connectable to WD 610 through an interface or port. Antenna 611, interface 614, and/or processing circuitry 620 may be configured to perform any receiving or transmitting operations described herein as being performed by a WD. Any information, data and/or signals may be received from a network node and/or another WD. In some embodiments, radio front end circuitry and/or antenna 611 may be considered an interface.

As illustrated, interface 614 comprises radio front end circuitry 612 and antenna 611. Radio front end circuitry 612 comprise one or more filters 618 and amplifiers 616. Radio front end circuitry 614 is connected to antenna 611 and processing circuitry 620, and is configured to condition signals communicated between antenna 611 and processing circuitry 620. Radio front end circuitry 612 may be coupled to or a part of antenna 611. In some embodiments, WD 610 may not include separate radio front end circuitry 612; rather, processing circuitry 620 may comprise radio front end circuitry and may be connected to antenna 611. Similarly, in some embodiments, some or all of RF transceiver circuitry 622 may be considered a part of interface 614. Radio front end circuitry 612 may receive digital data that is to be sent out to other network nodes or WDs via a wireless connection. Radio front end circuitry 612 may convert the digital data into a radio signal having the appropriate channel and bandwidth parameters using a combination of filters 618 and/or amplifiers 616. The radio signal may then be transmitted via antenna 611. Similarly, when receiving data, antenna 611 may collect radio signals which are then converted into digital data by radio front end circuitry 612. The digital data may be passed to processing circuitry 620. In other embodiments, the interface may comprise different components and/or different combinations of components.

Processing circuitry 620 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 610 components, such as device readable medium 630, WD 610 functionality. Such functionality may include providing any of the various wireless features or benefits discussed herein. For example, processing circuitry 620 may execute instructions stored in device readable medium 630 or in memory within processing circuitry 620 to provide the functionality disclosed herein.

As illustrated, processing circuitry 620 includes one or more of RF transceiver circuitry 622, baseband processing circuitry 624, and application processing circuitry 626. In other embodiments, the processing circuitry may comprise different components and/or different combinations of components. In certain embodiments processing circuitry 620 of WD 610 may comprise a SOC. In some embodiments, RF transceiver circuitry 622, baseband processing circuitry 624, and application processing circuitry 626 may be on separate chips or sets of chips. In alternative embodiments, part or all of baseband processing circuitry 624 and application processing circuitry 626 may be combined into one chip or set of chips, and RF transceiver circuitry 622 may be on a separate chip or set of chips. In still alternative embodiments, part or all of RF transceiver circuitry 622 and baseband processing circuitry 624 may be on the same chip or set of chips, and application processing circuitry 626 may be on a separate chip or set of chips. In yet other alternative embodiments, part or all of RF transceiver circuitry 622, baseband processing circuitry 624, and application processing circuitry 626 may be combined in the same chip or set of chips. In some embodiments, RF transceiver circuitry 622 may be a part of interface 614. RF transceiver circuitry 622 may condition RF signals for processing circuitry 620.

In certain embodiments, some or all of the functionality described herein as being performed by a WD may be provided by processing circuitry 620 executing instructions stored on device readable medium 630, which in certain embodiments may be a computer-readable storage medium. In alternative embodiments, some or all of the functionality may be provided by processing circuitry 620 without executing instructions stored on a separate or discrete device readable storage medium, such as in a hard-wired manner. In any of those particular embodiments, whether executing instructions stored on a device readable storage medium or not, processing circuitry 620 can be configured to perform the described functionality. The benefits provided by such functionality are not limited to processing circuitry 620 alone or to other components of WD 610, but are enjoyed by WD 610 as a whole, and/or by end users and the wireless network generally.

Processing circuitry 620 may be configured to perform any determining, calculating, or similar operations (e.g., certain obtaining operations) described herein as being performed by a WD. These operations, as performed by processing circuitry 620, may include processing information obtained by processing circuitry 620 by, for example, converting the obtained information into other information, comparing the obtained information or converted information to information stored by WD 610, and/or performing one or more operations based on the obtained information or converted information, and as a result of said processing making a determination.

Device readable medium 630 may be operable to store a computer program, software, an application including one or more of logic, rules, code, tables, etc. and/or other instructions capable of being executed by processing circuitry 620. Device readable medium 630 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 620. In some embodiments, processing circuitry 620 and device readable medium 630 may be considered to be integrated.

User interface equipment 632 may provide components that allow for a human user to interact with WD 610. Such interaction may be of many forms, such as visual, audial, tactile, etc. User interface equipment 632 may be operable to produce output to the user and to allow the user to provide input to WD 610. The type of interaction may vary depending on the type of user interface equipment 632 installed in WD 610. For example, if WD 610 is a smart phone, the interaction may be via a touch screen; if WD 610 is a smart meter, the interaction may be through a screen that provides usage (e.g., the number of gallons used) or a speaker that provides an audible alert (e.g., if smoke is detected). User interface equipment 632 may include input interfaces, devices and circuits, and output interfaces, devices and circuits. User interface equipment 632 is configured to allow input of information into WD 610, and is connected to processing circuitry 620 to allow processing circuitry 620 to process the input information. User interface equipment 632 may include, for example, a microphone, a proximity or other sensor, keys/buttons, a touch display, one or more cameras, a USB port, or other input circuitry. User interface equipment 632 is also configured to allow output of information from WD 610, and to allow processing circuitry 620 to output information from WD 610. User interface equipment 632 may include, for example, a speaker, a display, vibrating circuitry, a USB port, a headphone interface, or other output circuitry. Using one or more input and output interfaces, devices, and circuits, of user interface equipment 632, WD 610 may communicate with end users and/or the wireless network, and allow them to benefit from the functionality described herein.

Auxiliary equipment 634 is operable to provide more specific functionality which may not be generally performed by WDs. This may comprise specialized sensors for doing measurements for various purposes, interfaces for additional types of communication such as wired communications etc. The inclusion and type of components of auxiliary equipment 634 may vary depending on the embodiment and/or scenario.

Power source 636 may, in some embodiments, be in the form of a battery or battery pack. Other types of power sources, such as an external power source (e.g., an electricity outlet), photovoltaic devices or power cells, may also be used. WD 610 may further comprise power circuitry 637 for delivering power from power source 636 to the various parts of WD 610 which need power from power source 636 to carry out any functionality described or indicated herein. Power circuitry 637 may in certain embodiments comprise power management circuitry. Power circuitry 637 may additionally or alternatively be operable to receive power from an external power source; in which case WD 610 may be connectable to the exteral power source (such as an electricity outlet) via input circuitry or an interface such as an electrical power cable. Power circuitry 637 may also in certain embodiments be operable to deliver power from an external power source to power source 636. This may be, for example, for the charging of power source 636. Power circuitry 637 may perform any formatting, converting, or other modification to the power from power source 636 to make the power suitable for the respective components of WD 610 to which power is supplied.

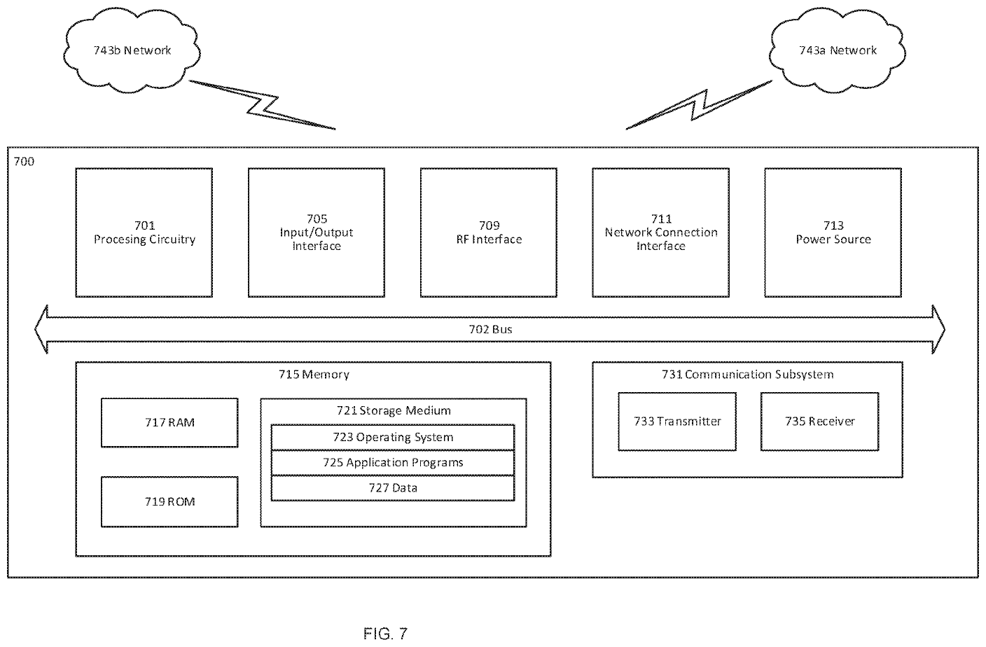

FIG. 7 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 700 may be any UE identified by the 3^{rd} Generation Partnership Project (3GPP), including a NB-IoT UE, a machine type communication (MTC) UE, and/or an enhanced MTC (eMTC) UE. UE 700, as illustrated in FIG. 7, is one example of a WD configured for communication in accordance with one or more communication standards promulgated by the 3^{rd} Generation Partnership Project (3GPP), such as 3GPP's GSM, UMTS, LTE, and/or 5G standards. As mentioned previously, the term WD and UE may be used interchangeable. Accordingly, although FIG. 7 is a UE, the components discussed herein are equally applicable to a WD, and vice-versa.

In FIG. 7, UE 700 includes processing circuitry 701 that is operatively coupled to input/output interface 705, radio frequency (RF) interface 709, network connection interface 711, memory 715 including random access memory (RAM) 717, read-only memory (ROM) 719, and storage medium 721 or the like, communication subsystem 731, power source 733, and/or any other component, or any combination thereof. Storage medium 721 includes operating system 723, application program 725, and data 727. In other embodiments, storage medium 721 may include other similar types of information. Certain UEs may utilize all of the components shown in FIG. 7, or only a subset of the components. The level of integration between the components may vary from one UE to another UE. Further, certain UEs may contain multiple instances of a component, such as multiple processors, memories, transceivers, transmitters, receivers, etc.

In FIG. 7, processing circuitry 701 may be configured to process computer instructions and data. Processing circuitry 701 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 701 may include two central processing units (CPUs). Data may be information in a form suitable for use by a computer.

In the depicted embodiment, input/output interface 705 may be configured to provide a communication interface to an input device, output device, or input and output device. UE 700 may be configured to use an output device via input/output interface 705. An output device may use the same type of interface port as an input device. For example, a USB port may be used to provide input to and output from UE 700. The output device may be a speaker, a sound card, a video card, a display, a monitor, a printer, an actuator, an emitter, a smartcard, another output device, or any combination thereof. UE 700 may be configured to use an input device via input/output interface 705 to allow a user to capture information into UE 700. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 7, RF interface 709 may be configured to provide a communication interface to RF components such as a transmitter, a receiver, and an antenna. Network connection interface 711 may be configured to provide a communication interface to network 743a. Network 743a may encompass wired and/or wireless networks such as a local-area network (LAN), a wide-area network (WAN), a computer network, a wireless network, a telecommunications network, another like network or any combination thereof. For example, network 743a may comprise a Wi-Fi network. Network connection interface 711 may be configured to include a receiver and a transmitter interface used to communicate with one or more other devices over a communication network according to one or more communication protocols, such as Ethernet, TCP/IP, SONET, ATM, or the like. Network connection interface 711 may implement receiver and transmitter functionality appropriate to the communication network links (e.g., optical, electrical, and the like). The transmitter and receiver functions may share circuit components, software or firmware, or alternatively may be implemented separately.

RAM 717 may be configured to interface via bus 702 to processing circuitry 701 to provide storage or caching of data or computer instructions during the execution of software programs such as the operating system, application programs, and device drivers. ROM 719 may be configured to provide computer instructions or data to processing circuitry 701. For example, ROM 719 may be configured to store invariant low-level system code or data for basic system functions such as basic input and output (I/O), startup, or reception of keystrokes from a keyboard that are stored in a non-volatile memory. Storage medium 721 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 721 may be configured to include operating system 723, application program 725 such as a web browser application, a widget or gadget engine or another application, and data file 727. Storage medium 721 may store, for use by UE 700, any of a variety of various operating systems or combinations of operating systems.

Storage medium 721 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 721 may allow UE 700 to access computer-executable instructions, application programs or the like, stored on transitory or non-transitory memory media, to off-load data, or to upload data. An article of manufacture, such as one utilizing a communication system may be tangibly embodied in storage medium 721, which may comprise a device readable medium.

In FIG. 7, processing circuitry 701 may be configured to communicate with network 743b using communication subsystem 731. Network 743a and network 743b may be the same network or networks or different network or networks. Communication subsystem 731 may be configured to include one or more transceivers used to communicate with network 743b. For example, communication subsystem 731 may be configured to include one or more transceivers used to communicate with one or more remote transceivers of another device capable of wireless communication such as another WD, UE, or base station of a radio access network (RAN) according to one or more communication protocols, such as IEEE 802.7, CDMA, WCDMA, GSM, LTE, UTRAN, WMax, or the like. Each transceiver may include transmitter 733 and/or receiver 735 to implement transmitter or receiver functionality, respectively, appropriate to the RAN links (e.g., frequency allocations and the like). Further, transmitter 733 and receiver 735 of each transceiver may share circuit components, software or firmware, or alternatively may be implemented separately.

In the illustrated embodiment, the communication functions of communication subsystem 731 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 731 may include cellular communication, W-Fi communication, Bluetooth communication, and GPS communication. Network 743b may encompass wired and/or wireless networks such as a local-area network (LAN), a wide-area network (WAN), a computer network, a wireless network, a telecommunications network, another like network or any combination thereof. For example, network 743b may be a cellular network, a Wi-Fi network, and/or a near-field network. Power source 713 may be configured to provide alternating current (AC) or direct current (DC) power to components of UE 700.

The features, benefits and/or functions described herein may be implemented in one of the components of UE 700 or partitioned across multiple components of UE 700. Further, the features, benefits, and/or functions described herein may be implemented in any combination of hardware, software or firmware. In one example, communication subsystem 731 may be configured to include any of the components described herein. Further, processing circuitry 701 may be configured to communicate with any of such components over bus 702. In another example, any of such components may be represented by program instructions stored in memory that when executed by processing circuitry 701 perform the corresponding functions described herein. In another example, the functionality of any of such components may be partitioned between processing circuitry 701 and communication subsystem 731. In another example, the non-computationally intensive functions of any of such components may be implemented in software or firmware and the computationally intensive functions may be implemented in hardware.

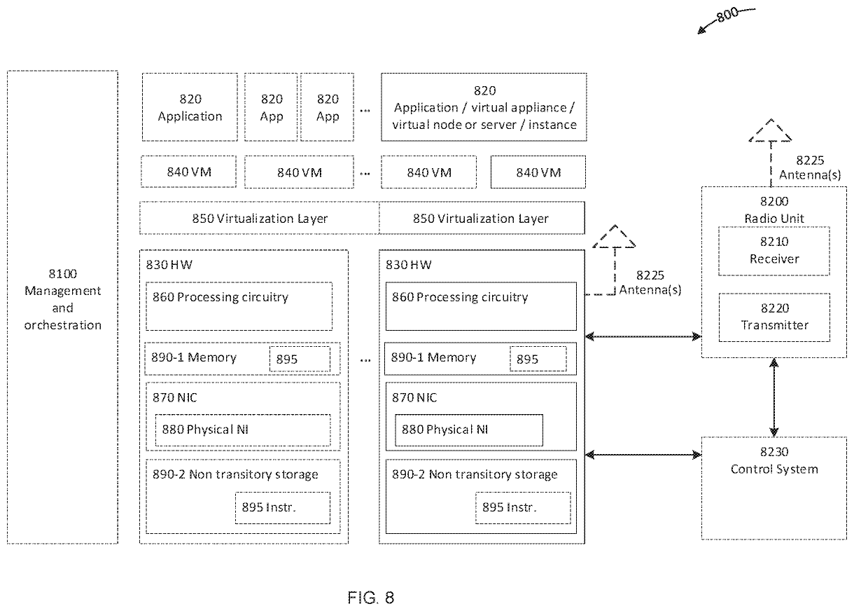

FIG. 8 is a schematic block diagram illustrating a virtualization environment 800 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 800 hosted by one or more of hardware nodes 830. Further, in embodiments in which the virtual node is not a radio access node or does not require radio connectivity (e.g., a core network node), then the network node may be entirely virtualized.

The functions may be implemented by one or more applications 820 (which may alternatively be called software instances, virtual appliances, network functions, virtual nodes, virtual network functions, etc.) operative to implement some of the features, functions, and/or benefits of some of the embodiments disclosed herein. Applications 820 are run in virtualization environment 800 which provides hardware 830 comprising processing circuitry 860 and memory 890. Memory 890 contains instructions 895 executable by processing circuitry 860 whereby application 820 is operative to provide one or more of the features, benefits, and/or functions disclosed herein.

Virtualization environment 800, comprises general-purpose or special-purpose network hardware devices 830 comprising a set of one or more processors or processing circuitry 860, which may be commercial off-the-shelf (COTS) processors, dedicated Application Specific Integrated Circuits (ASICs), or any other type of processing circuitry including digital or analog hardware components or special purpose processors. Each hardware device may comprise memory 890-1 which may be non-persistent memory for temporarily storing instructions 895 or software executed by processing circuitry 860. Each hardware device may comprise one or more network interface controllers (NICs) 870, also known as network interface cards, which include physical network interface 880. Each hardware device may also include non-transitory, persistent, machine-readable storage media 890-2 having stored therein software 895 and/or instructions executable by processing circuitry 860. Software 895 may include any type of software including software for instantiating one or more virtualization layers 850 (also referred to as hypervisors), software to execute virtual machines 840 as well as software allowing it to execute functions, features and/or benefits described in relation with some embodiments described herein.

Virtual machines 840, comprise virtual processing, virtual memory, virtual networking or interface and virtual storage, and may be run by a corresponding virtualization layer 850 or hypervisor. Different embodiments of the instance of virtual appliance 820 may be implemented on one or more of virtual machines 840, and the implementations may be made in different ways.

During operation, processing circuitry 860 executes software 895 to instantiate the hypervisor or virtualization layer 850, which may sometimes be referred to as a virtual machine monitor (VMM). Virtualization layer 850 may present a virtual operating platform that appears like networking hardware to virtual machine 840.

As shown in FIG. 8, hardware 830 may be a standalone network node with generic or specific components. Hardware 830 may comprise antenna 8225 and may implement some functions via virtualization. Alternatively, hardware 830 may be part of a larger cluster of hardware (e.g. such as in a data center or customer premise equipment (CPE)) where many hardware nodes work together and are managed via management and orchestration (MANO) 8100, which, among others, oversees lifecycle management of applications 820.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment In the context of NFV, virtual machine 840 may be a software implementation of a physical machine that runs programs as if they were executing on a physical, non-virtualized machine. Each of virtual machines 840, and that part of hardware 830 that executes that virtual machine, be it hardware dedicated to that virtual machine and/or hardware shared by that virtual machine with others of the virtual machines 840, forms a separate virtual network elements (VNE).

Still in the context of NFV, Virtual Network Function (VNF) is responsible for handling specific network functions that run in one or more virtual machines 840 on top of hardware networking infrastructure 830 and corresponds to application 820 in FIG. 8.

In some embodiments, one or more radio units 8200 that each include one or more transmitters 8220 and one or more receivers 8210 may be coupled to one or more antennas 8225. Radio units 8200 may communicate directly with hardware nodes 830 via one or more appropriate network interfaces and may be used in combination with the virtual components to provide a virtual node with radio capabilities, such as a radio access node or a base station.

In some embodiments, some signalling can be effected with the use of control system 8230 which may alternatively be used for communication between the hardware nodes 830 and radio units 8200.

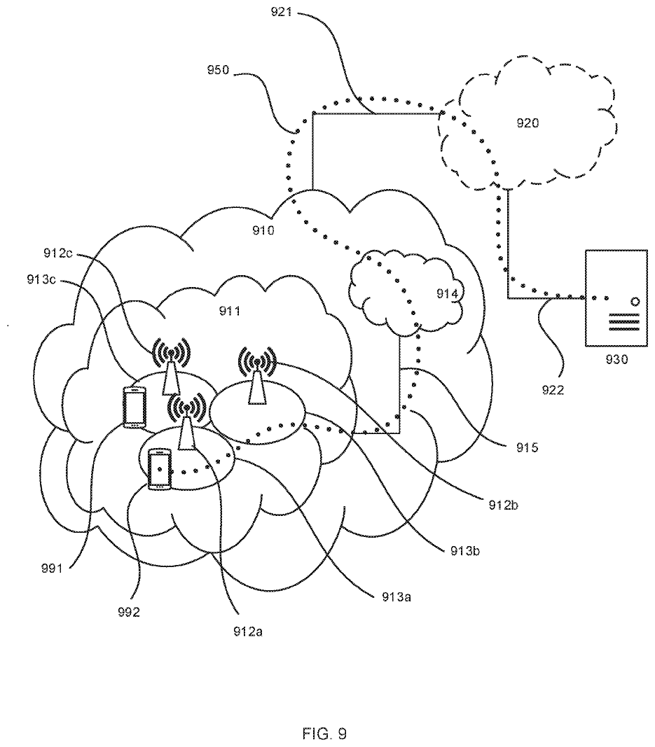

With reference to FIG. 9, in accordance with an embodiment, a communication system includes telecommunication network 910, such as a 3GPP-type cellular network, which comprises access network 911, such as a radio access network, and core network 914. Access network 911 comprises a plurality of base stations 912a, 912b, 912c, such as NBs, eNBs, gNBs or other types of wireless access points, each defining a corresponding coverage area 913a, 913b, 913c. Each base station 912a, 912b, 912c is connectable to core network 914 over a wired or wireless connection 915. A first UE 991 located in coverage area 913c is configured to wirelessly connect to, or be paged by, the corresponding base station 912c. A second UE 992 in coverage area 913a is wirelessly connectable to the corresponding base station 912a. While a plurality of UEs 991, 992 are illustrated in this example, the disclosed embodiments are equally applicable to a situation where a sole UE is in the coverage area or where a sole UE is connecting to the corresponding base station 912.

Telecommunication network 910 is itself connected to host computer 930, which may be embodied in the hardware and/or software of a standalone server, a cloud-implemented server, a distributed server or as processing resources in a server farm. Host computer 930 may be under the ownership or control of a service provider, or may be operated by the service provider or on behalf of the service provider. Connections 921 and 922 between telecommunication network 910 and host computer 930 may extend directly from core network 914 to host computer 930 or may go via an optional intermediate network 920. Intermediate network 920 may be one of, or a combination of more than one of, a public, private or hosted network; intermediate network 920, if any, may be a backbone network or the Internet; in particular, intermediate network 920 may comprise two or more sub-networks (not shown).

The communication system of FIG. 9 as a whole enables connectivity between the connected UEs 991, 992 and host computer 930. The connectivity may be described as an over-the-top (OTT) connection 950. Host computer 930 and the connected UEs 991, 992 are configured to communicate data and/or signaling via OTT connection 950, using access network 911, core network 914, any intermediate network 920 and possible further infrastructure (not shown) as intermediaries. OTT connection 950 may be transparent in the sense that the participating communication devices through which OTT connection 950 passes are unaware of routing of uplink and downlink communications. For example, base station 912 may not or need not be informed about the past routing of an incoming downlink communication with data originating from host computer 930 to be forwarded (e.g., handed over) to a connected UE 991. Similarly, base station 912 need not be aware of the future routing of an outgoing uplink communication originating from the UE 991 towards the host computer 930.

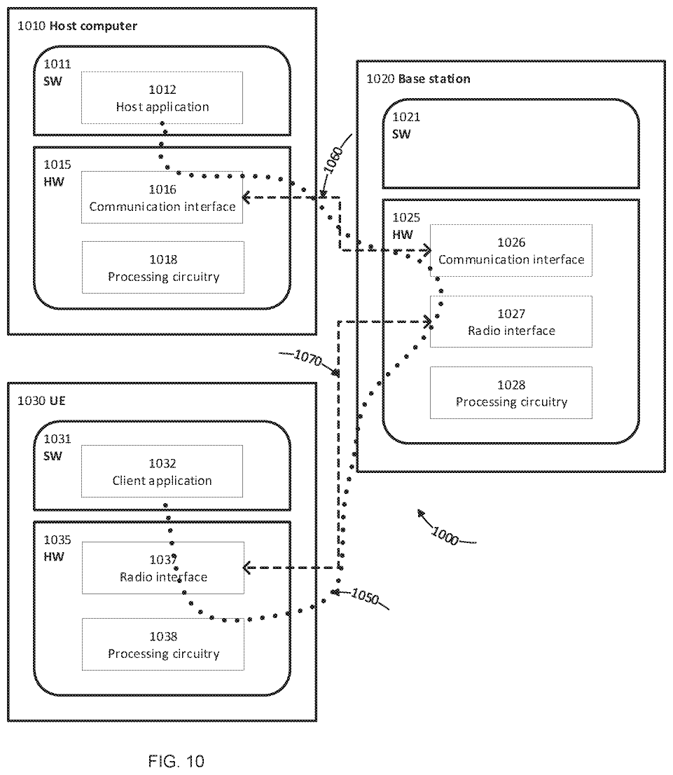

Example implementations, in accordance with an embodiment, of the UE, base station and host computer discussed in the preceding paragraphs will now be described with reference to FIG. 10. In communication system 1000, host computer 1010 comprises hardware 1015 including communication interface 1016 configured to set up and maintain a wired orwireless connection with an interface of a different communication device of communication system 1000. Host computer 1010 further comprises processing circuitry 1018, which may have storage and/or processing capabilities. In particular, processing circuitry 1018 may comprise one or more programmable processors, application-specific integrated circuits, field programmable gate arrays or combinations of these (not shown) adapted to execute instructions. Host computer 1010 further comprises software 1011, which is stored in or accessible by host computer 1010 and executable by processing circuitry 1018. Software 1011 includes host application 1012. Host application 1012 may be operable to provide a service to a remote user, such as UE 1030 connecting via OTT connection 1050 terminating at UE 1030 and host computer 1010. In providing the service to the remote user, host application 1012 may provide user data which is transmitted using OTT connection 1050.

Communication system 1000 further includes base station 1020 provided in a telecommunication system and comprising hardware 1025 enabling it to communicate with host computer 1010 and with UE 1030. Hardware 1025 may include communication interface 1026 for setting up and maintaining a wired or wireless connection with an interface of a different communication device of communication system 1000, as well as radio interface 1027 for setting up and maintaining at least wireless connection 1070 with UE 1030 located in a coverage area (not shown in FIG. 10) served by base station 1020. Communication interface 1026 may be configured to facilitate connection 1060 to host computer 1010. Connection 1060 may be direct or it may pass through a core network (not shown in FIG. 10) of the telecommunication system and/or through one or more intermediate networks outside the telecommunication system. In the embodiment shown, hardware 1025 of base station 1020 further includes processing circuitry 1028, which may comprise one or more programmable processors, application-specific integrated circuits, field programmable gate arrays or combinations of these (not shown) adapted to execute instructions. Base station 1020 further has software 1021 stored internally or accessible via an external connection.

Communication system 1000 further includes UE 1030 already referred to. Its hardware 1035 may include radio interface 1037 configured to set up and maintain wireless connection 1070 with a base station serving a coverage area in which UE 1030 is currently located. Hardware 1035 of UE 1030 further includes processing circuitry 1038, which may comprise one or more programmable processors, application-specific integrated circuits, field programmable gate arrays or combinations of these (not shown) adapted to execute instructions. UE 1030 further comprises software 1031, which is stored in or accessible by UE 1030 and executable by processing circuitry 1038. Software 1031 includes client application 1032. Client application 1032 may be operable to provide a service to a human or non-human user via UE 1030, with the support of host computer 1010. In host computer 1010, an executing host application 1012 may communicate with the executing client application 1032 via OTT connection 1050 terminating at UE 1030 and host computer 1010. In providing the service to the user, client application 1032 may receive request data from host application 1012 and provide user data in response to the request data. OTT connection 1050 may transfer both the request data and the user data. Client application 1032 may interact with the user to generate the user data that it provides.

It is noted that host computer 1010, base station 1020 and UE 1030 illustrated in FIG. 10 may be similar or identical to host computer 930, one of base stations 912a, 912b, 912c and one of UEs 991, 992 of FIG. 9, respectively. This is to say, the inner workings of these entities may be as shown in FIG. 10 and independently, the surrounding network topology may be that of FIG. 9.

In FIG. 10, OTT connection 1050 has been drawn abstractly to illustrate the communication between host computer 1010 and UE 1030 via base station 1020, without explicit reference to any intermediary devices and the precise routing of messages via these devices. Network infrastructure may determine the routing, which it may be configured to hide from UE 1030 or from the service provider operating host computer 1010, or both. While OTT connection 1050 is active, the network infrastructure may further take decisions by which it dynamically changes the routing (e.g., on the basis of load balancing consideration or reconfiguration of the network).

Wireless connection 1070 between UE 1030 and base station 1020 is in accordance with the teachings of the embodiments described throughout this disclosure. One or more of the various embodiments improve the performance of OTT services provided to UE 1030 using OTT connection 1050, in which wireless connection 1070 forms the last segment. More precisely, the teachings of these embodiments may improve none or one or more of UL MIMO codebook issues such as the design of 4 port UL MIMO codebooks, the amount of TPMI, TRI, and SRI overhead that may be available for UL MIMO, how TPMI, TRI, and SRI can be encoded, the benefit of frequency selective precoding, whether TPMI should be persistent, whether TPMI or SRI should be used for antenna selection, the number of ports and layers UL SU-MIMO and the codebook should be designed for, as well as support for non-coherent transmission through the use of multiple SRI and/or TPMI and thereby may provide none or one or more of benefits such as reduced user waiting time, relaxed restriction on file size, better responsiveness, extended battery lifetime.

A measurement procedure may be provided for the purpose of monitoring data rate, latency and other factors on which the one or more embodiments improve. There may further be an optional network functionality for reconfiguring OTT connection 1050 between host computer 1010 and UE 1030, in response to variations in the measurement results. The measurement procedure and/or the network functionality for reconfiguring OTT connection 1050 may be implemented in software 1011 and hardware 1015 of host computer 1010 or in software 1031 and hardware 1035 of UE 1030, or both.

In embodiments, sensors (not shown) may be deployed in or in association with communication devices through which OTT connection 1050 passes; the sensors may participate in the measurement procedure by supplying values of the monitored quantities exemplified above, or supplying values of other physical quantities from which software 1011, 1031 may compute or estimate the monitored quantities. The reconfiguring of OTT connection 1050 may include message format, retransmission settings, preferred routing etc.; the reconfiguring need not affect base station 1020, and it may be unknown or imperceptible to base station 1020. Such procedures and functionalities may be known and practiced in the art. In certain embodiments, measurements may involve proprietary UE signaling facilitating host computer 1010's measurements of throughput, propagation times, latency and the like. The measurements may be implemented in that software 1011 and 1031 causes messages to be transmitted, in particular empty or ‘dummy’ messages, using OTT connection 1050 while it monitors propagation times, errors etc.

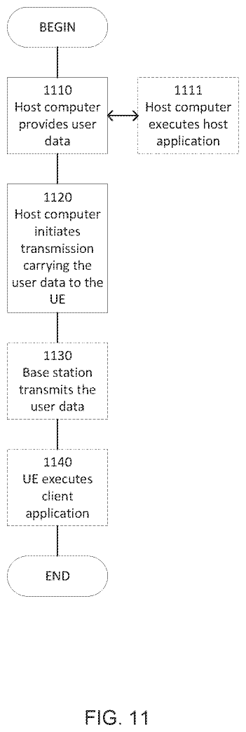

FIG. 11 is a flowchart illustrating a method implemented in a communication system, in accordance with one embodiment. The communication system includes a host computer, a base station and a UE which may be those described with reference to FIGS. 9 and 10. For simplicity of the present disclosure, only drawing references to FIG. 11 will be included in this section. In step 1110, the host computer provides user data. In substep 1111 (which may be optional) of step 1110, the host computer provides the user data by executing a host application. In step 1120, the host computer initiates a transmission carrying the user data to the UE. In step 1130 (which may be optional), the base station transmits to the UE the user data which was carried in the transmission that the host computer initiated, in accordance with the teachings of the embodiments described throughout this disclosure. In step 1140 (which may also be optional), the UE executes a client application associated with the host application executed by the host computer.

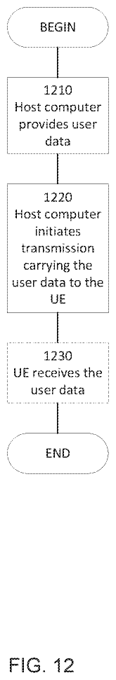

FIG. 12 is a flowchart illustrating a method implemented in a communication system, in accordance with one embodiment. The communication system includes a host computer, a base station and a UE which may be those described with reference to FIGS. 9 and 10. For simplicity of the present disclosure, only drawing references to FIG. 12 will be included in this section. In step 1210 of the method, the host computer provides user data. In an optional substep (not shown) the host computer provides the user data by executing a host application. In step 1220, the host computer initiates a transmission carrying the user data to the UE. The transmission may pass via the base station, in accordance with the teachings of the embodiments described throughout this disclosure. In step 1230 (which may be optional), the UE receives the user data carried in the transmission.

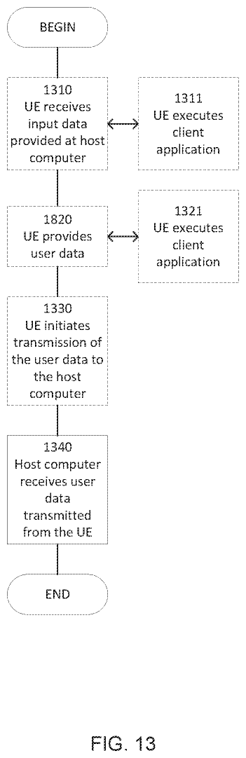

FIG. 13 is a flowchart illustrating a method implemented in a communication system, in accordance with one embodiment. The communication system includes a host computer, a base station and a UE which may be those described with reference to FIGS. 9 and 10. For simplicity of the present disclosure, only drawing references to FIG. 13 will be included in this section. In step 1310 (which may be optional), the UE receives input data provided by the host computer. Additionally or alternatively, in step 1320, the UE provides user data. In substep 1321 (which may be optional) of step 1320, the UE provides the user data by executing a client application. In substep 1311 (which may be optional) of step 1310, the UE executes a client application which provides the user data in reaction to the received input data provided by the host computer. In providing the user data, the executed client application may further consider user input received from the user. Regardless of the specific manner in which the user data was provided, the UE initiates, in substep 1330 (which may be optional), transmission of the user data to the host computer. In step 1340 of the method, the host computer receives the user data transmitted from the UE, in accordance with the teachings of the embodiments described throughout this disclosure.

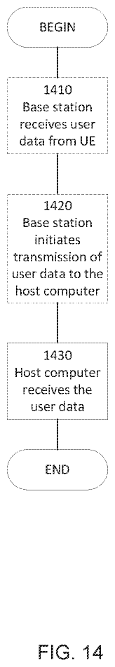

FIG. 14 is a flowchart illustrating a method implemented in a communication system, in accordance with one embodiment. The communication system includes a host computer, a base station and a UE which may be those described with reference to FIGS. 9 and 10. For simplicity of the present disclosure, only drawing references to FIG. 14 will be included in this section. In step 1410 (which may be optional), in accordance with the teachings of the embodiments described throughout this disclosure, the base station receives user data from the UE. In step 1420 (which may be optional), the base station initiates transmission of the received user data to the host computer. In step 1430 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

According to one aspect, this disclosure provides embodiments to jointly encode TPMI with SRS resource selection using multiple SRIs but using a fixed field size. In some embodiments, the number of ports in the aggregated resource indicated by the multiple SRI varies. Similarly, in other embodiments, the number of SRS resources that is selected can also vary.

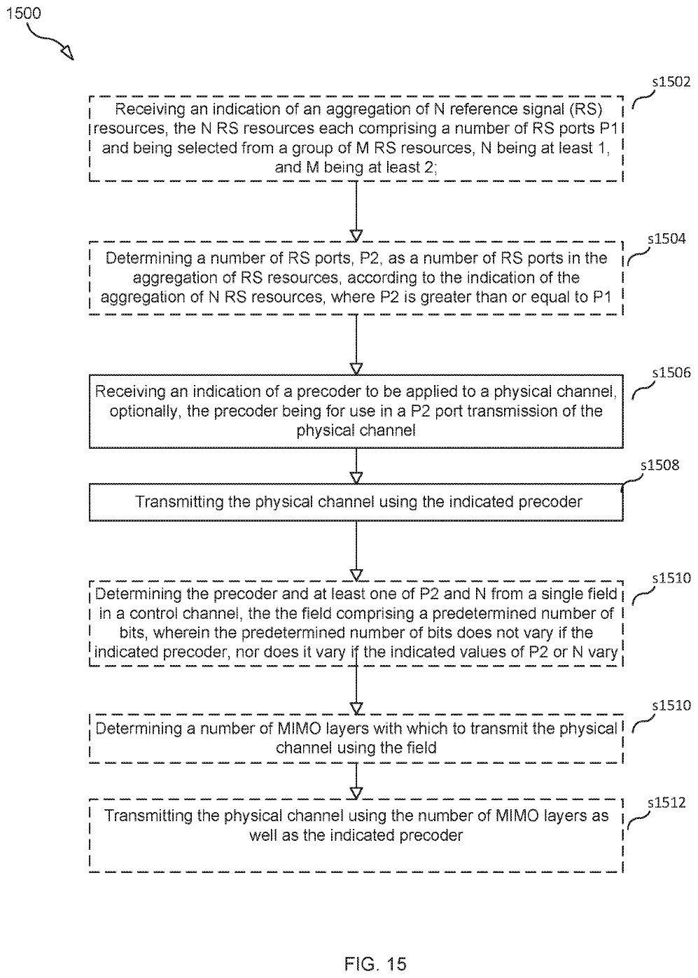

FIG. 15 depicts a method in accordance with particular embodiments, of determining antenna ports and precoding to be used in transmission. Step 1502 (optional) is receiving an indication of an aggregation of N reference signal (RS) resources, the N RS resources each comprising a number of RS ports P1 and being selected from a group of M RS resources, N being at least 1, and M being at least 2. Step 1504 (optional) is determining a number of RS ports, P2, as a number of RS ports in the aggregation of RS resources, according to the indication of the aggregation of N RS resources, where P2 is greater than or equal to P1. Step 1506 is receiving an indication of a precoder to be applied to a physical channel, optionally, the precoder being for use in a P2 port transmission of the physical channel. Step 1508 is transmitting the physical channel using the indicated precoder. Step 1510 (optional) is determining the precoder and at least one of P2 and N from a single field in a control channel, the field comprising a predetermined number of bits, wherein the predetermined number of bits does not vary if the indicated precoder, nor does it vary if the indicated values of P2 or N vary. Step 1512 (optional) is determining a number of MIMO layers with which to transmit the physical channel using the field. Step 1514 (optional) is transmitting the physical channel using the number of MIMO layers as well as the indicated precoder.

According to another aspect, this disclosure provides embodiments to use a default precoding matrix for non-coherent multi-layer transmission using multiple SRI.

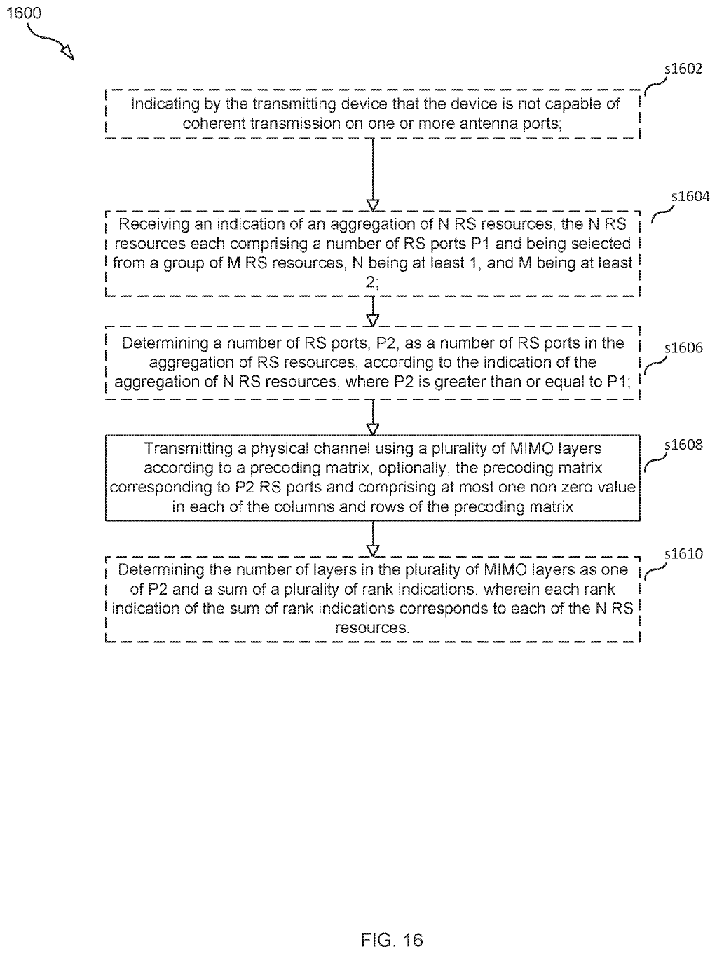

FIG. 16 depicts a method in accordance with particular embodiments of the second aspect, of transmitting multiple layers using an aggregation of reference signal (RS) resources. Step 1602 (optional) is indicating by the transmitting device that the device is not capable of coherent transmission on one or more antenna ports. Step 1604 (optional) is receiving an indication of an aggregation of N RS resources, the N RS resources each comprising a number of RS ports P1 and being selected from a group of M RS resources, N being at least 1, and M being at least 2. Step 1606 (optional) is determining a number of RS ports, P2, as a number of RS ports in the aggregation of RS resources, according to the indication of the aggregation of N RS resources, where P2 is greater than or equal to P1. Step 1608 is transmitting a physical channel using a plurality of MIMO layers according to a precoding matrix, optionally the precoding matrix corresponding to P2 RS ports and comprising at most one non zero value in each of the columns and rows of the precoding matrix. Step 1610 (optional) is determining the number of layers in the plurality of MIMO layers as one of P2 and a sum of a plurality of rank indications, wherein each rank indication of the sum of rank indications corresponds to each of the N RS resources.

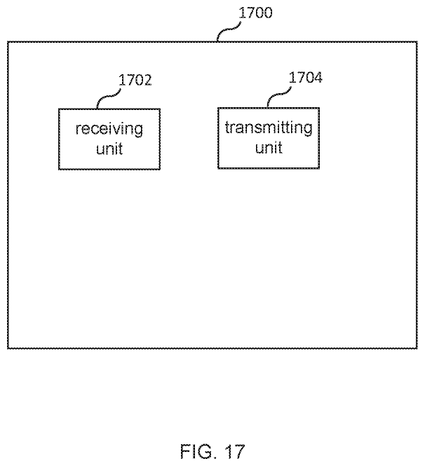

FIG. 17 illustrates a schematic block diagram of a virtual apparatus 1700 in a wireless network (for example, the wireless network shown in FIG. 6). The apparatus may be implemented in a wireless device or network node (e.g., wireless device 610 or network node 660 shown in FIG. 6). Apparatus 1700 is operable to carry out the example method described with reference to FIG. 15 and possibly any other processes or methods disclosed herein. It is also to be understood that the method of FIG. 15 is not necessarily carried out solely by apparatus 1700. At least some operations of the method can be performed by one or more other entities.

Virtual Apparatus 1700 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause receiving unit 1702, transmitting unit 1704, and any other suitable units of apparatus 1700 to perform corresponding functions according one or more embodiments of the present disclosure.

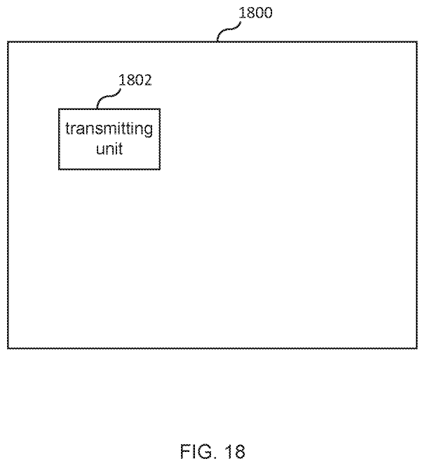

FIG. 18 illustrates a schematic block diagram of a virtual apparatus 1800 in a wireless network (for example, the wireless network shown in FIG. 6). The apparatus may be implemented in a wireless device or network node (e.g., wireless device 610 or network node 660 shown in FIG. 6). Apparatus 1800 is operable to carry out the example method described with reference to FIG. 16 and possibly any other processes or methods disclosed herein. It is also to be understood that the method of FIG. 16 is not necessarily carried out solely by apparatus 1800. At least some operations of the method can be performed by one or more other entities.

Virtual Apparatus 1800 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause transmitting unit 1802 and any other suitable units of apparatus 1800 to perform corresponding functions according one or more embodiments of the present disclosure.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Some embodiments include:

### Group A Embodiments

1. A method performed by a transmitting device, the method comprising at least one of
a. Receiving an indication of an aggregation of N reference signal (RS) resources, the N RS resources each comprising a number of RS ports P1 and being selected from a group of M RS resources, N being at least 1, and M being at least 2;
b. Determining a number of RS ports, P2, as a number of RS ports in the aggregation of RS resources, according to the indication of the aggregation of N RS resources, where P2 is greater than or equal to P1;
c. Receiving an indication of a precoder to be applied to a physical channel, the precoder being for use in a P2 port transmission of the physical channel; and
d. Transmitting the physical channel using the indicated precoder 2. The method of Embodiment 1, further comprising determining the precoder and at least one of P2 and N from a single field in a control channel, the field comprising a predetermined number of bits, wherein the predetermined number of bits does not vary with the indicated precoder, nor does it vary if the indicated values of P2 or N vary.

3. The method of Embodiment 2, further comprising at least one of:
a. determining a number of MIMO layers with which to transmit the physical channel using the field; and
b. Transmitting the physical channel using the number of MIMO layers as well as the indicated precoder.

4. The method of any of the previous embodiments, further comprising:
providing user data; and
forwarding the user data to a host computer via the transmission to the base station.

### Group B Embodiments

5. A method performed by a transmitting device, the method comprising at least one of:
a. Receiving an indication of an aggregation of N reference signal (RS) resources, the N RS resources each comprising a number of RS ports P1 and being selected from a group of M RS resources, N being at least 1, and M being at least 2;
b. Determining a number of RS ports, P2, as a number of RS ports in the aggregation of RS resources, according to the indication of the aggregation of N RS resources, where P2 is greater than or equal to P1;
c. Receiving an indication of a precoder to be applied to a physical channel, the precoder being for use in a P2 port transmission of the physical channel; and
d. Transmitting the physical channel using the indicated precoder

6. The method of Embodiment 1, further comprising determining the number of layers in the plurality of MIMO layers as one of P2 and a sum of a plurality of rank indications, wherein each rank indication of the sum of rank indications corresponds to each of the N RS resources.

7. The method of any of the previous embodiments, further comprising:
providing user data; and
forwarding the user data to a host computer via the transmission to the base station.

### Group C Embodiments

8. A method performed wherein the transmitting device is either a wireless device such as a user equ

9. The method of any of the previous embodiments, further comprising:
obtaining user data; and
forwarding the user data to a host computer or a wireless device.

### Group D Embodiments

10. A the wireless device comprising:
processing circuitry configured to perform any of the steps of any of the Group A, Group B or Group C embodiments; and
power supply circuitry configured to supply power to the wireless device.

11. A base station comprising:
processing circuitry configured to perform any of the steps of any of the Group A or B embodiments;
power supply circuitry configured to supply power to the wireless device.

12. A user equipment (UE) comprising:
an antenna configured to send and receive wireless signals;
radio front-end circuitry connected to the antenna and to processing circuitry, and configured to condition signals communicated between the antenna and the processing circuitry;
the processing circuitry being configured to perform any of the steps of any of the Group A embodiments;
an input interface connected to the processing circuitry and configured to allow input of information into the UE to be processed by the processing circuitry;
an output interface connected to the processing circuitry and configured to output information from the UE that has been processed by the processing circuitry; and
a battery connected to the processing circuitry and configured to supply power to the UE.

13. A communication system including a host computer comprising:
processing circuitry configured to provide user data; and
a communication interface configured to forward the user data to a cellular network for transmission to a user equipment (UE),
wherein the cellular network comprises a base station having a radio interface and processing circuitry, the base station's processing circuitry configured to perform any of the steps of any of the Group B embodiments.

14. The communication system of the pervious embodiment further including the base station.

15. The communication system of the previous 2 embodiments, further including the UE, wherein the UE is configured to communicate with the base station.

16. The communication system of the previous 3 embodiments, wherein:
the processing circuitry of the host computer is configured to execute a host application, thereby providing the user data; and
the UE comprises processing circuitry configured to execute a client application associated with the host application.

17. A method implemented in a communication system including a host computer, a base station and a user equipment (UE), the method comprising:
at the host computer, providing user data; and
at the host computer, initiating a transmission carrying the user data to the UE via a cellular network comprising the base station, wherein the base station performs any of the steps of any of the Group B embodiments.

18. The method of the previous embodiment, further comprising, at the base station, transmitting the user data.

19. The method of the previous 2 embodiments, wherein the user data is provided at the host computer by executing a host application, the method further comprising, at the UE, executing a client application associated with the host application.

20. A user equipment (UE) configured to communicate with a base station, the UE comprising a radio interface and processing circuitry configured to performs the of the previous 3 embodiments.

21. A communication system including a host computer comprising:
processing circuitry configured to provide user data; and
a communication interface configured to forward user data to a cellular network for transmission to a user equipment (UE),
wherein the UE comprises a radio interface and processing circuitry, the UE's components configured to perform any of the steps of any of the Group A embodiments.

22. The communication system of the previous embodiment, wherein the cellular network further includes a base station configured to communicate with the UE.

23. The communication system of the previous 2 embodiments, wherein:
the processing circuitry of the host computer is configured to execute a host application, thereby providing the user data; and
the UE's processing circuitry is configured to execute a client application associated with the host application.

24. A method implemented in a communication system including a host computer, a base station and a user equipment (UE), the method comprising:
at the host computer, providing user data; and
at the host computer, initiating a transmission carrying the user data to the UE via a cellular network comprising the base station, wherein the UE performs any of the steps of any of the Group A embodiments.

25. The method of the previous embodiment, further comprising at the UE, receiving the user data from the base station.

26. A communication system including a host computer comprising:
communication interface configured to receive user data originating from a transmission from a user equipment (UE) to a base station,
wherein the UE comprises a radio interface and processing circuitry, the UE's processing circuitry configured to perform any of the steps of any of the Group A embodiments.

27. The communication system of the previous embodiment, further including the UE.

28. The communication system of the previous 2 embodiments, further including the base station, wherein the base station comprises a radio interface configured to communicate with the UE and a communication interface configured to forward to the host computer the user data carried by a transmission from the UE to the base station.

29. The communication system of the previous 3 embodiments, wherein:
the processing circuitry of the host computer is configured to execute a host application; and
the UE's processing circuitry is configured to execute a client application associated with the host application, thereby providing the user data.

30. The communication system of the previous 4 embodiments, wherein:
the processing circuitry of the host computer is configured to execute a host application, thereby providing request data; and
the UE's processing circuitry is configured to execute a client application associated with the host application, thereby providing the user data in response to the request data.

31. A method implemented in a communication system including a host computer, a base station and a user equipment (UE), the method comprising:
at the host computer, receiving user data transmitted to the base station from the UE, wherein the UE performs any of the steps of any of the Group A embodiments.

32. The method of the previous embodiment, further comprising, at the UE, providing the user data to the base station.

33. The method of the previous 2 embodiments, further comprising:
at the UE, executing a client application, thereby providing the user data to be transmitted; and
at the host computer, executing a host application associated with the client application.

34. The method of the previous 3 embodiments, further comprising:
at the UE, executing a client application; and
at the UE, receiving input data to the client application, the input data being provided at the host computer by executing a host application associated with the client application,
wherein the user data to be transmitted is provided by the client application in response to the input data.

35. A communication system including a host computer comprising a communication interface configured to receive user data originating from a transmission from a user equipment (UE) to a base station, wherein the base station comprises a radio interface and processing circuitry, the base station's processing circuitry configured to perform any of the steps of any of the Group B embodiments.

36. The communication system of the previous embodiment further including the base station.

37. The communication system of the previous 2 embodiments, further including the UE, wherein the UE is configured to communicate with the base station.

38. The communication system of the previous 3 embodiments, wherein:
the processing circuitry of the host computer is configured to execute a host application;
the UE is configured to execute a client application associated with the host application, thereby providing the user data to be received by the host computer.

39. A method implemented in a communication system including a host computer, a base station and a user equipment (UE), the method comprising:
at the host computer, receiving, from the base station, user data originating from a transmission which the base station has received from the UE, wherein the UE performs any of the steps of any of the Group A embodiments.

40. The method of the previous embodiment, further comprising at the base station, receiving the user data from the UE.

41. The method of the previous 2 embodiments, further comprising at the base station, initiating a transmission of the received user data to the host computer.

### Abbreviations

At least some of the following abbreviations may be used in this disclosure. If there is an inconsistency between abbreviations, preference should be given to how it is used above. If listed multiple times below, the first listing should be preferred over any subsequent listing(s).
1×RTT CDMA2000 1× Radio Transmission Technology
3GPP 3rd Generation Partnership Project
5G 5th Generation
ABS Almost Blank Subframe
ARQ Automatic Repeat Request
AWGN Additive White Gaussian Noise
BCCH Broadcast Control Channel
BCH Broadcast Channel
CA Carrier Aggregation
CC Carrier Component
CCCH SDU Common Control Channel SDU
CDMA Code Division Multiplexing Access
CGI Cell Global Identifier
CIR Channel Impulse Response
CP Cyclic Prefix
CPICH Common Pilot Channel
CPICH Ec/No CPICH Received energy per chip divided by the power density in the band
CQI Channel Quality information
C-RNTI Cell RNTI
CSI Channel State Information
DCCH Dedicated Control Channel
DL Downlink
DM Demodulation
DMRS Demodulation Reference Signal
DRX Discontinuous Reception
DTX Discontinuous Transmission
DTCH Dedicated Traffic Channel
DUT Device Under Test
E-CID Enhanced Cell-ID (positioning method)
E-SMLC Evolved-Serving Mobile Location Centre
ECGI Evolved CGI
eNB E-UTRAN NodeB
ePDCCH enhanced Physical Downlink Control Channel
E-SMLC evolved Serving Mobile Location Center
E-UTRA Evolved UTRA
E-UTRAN Evolved UTRAN
FDD Frequency Division Duplex
FFS For Further Study
GERAN GSM EDGE Radio Access Network
gNB Base station in NR
GNSS Global Navigation Satellite System
GSM Global System for Mobile communication
HARQ Hybrid Automatic Repeat Request
HO Handover
HSPA High Speed Packet Access
HRPD High Rate Packet Data
LOS Line of Sight
LPP LTE Positioning Protocol
LTE Long-Term Evolution
MAC Medium Access Control
MBMS Multimedia Broadcast Multicast Services
MBSFN Multimedia Broadcast multicast service Single Frequency Network
MBSFN ABS MBSFN Almost Blank Subframe
MDT Minimization of Drive Tests
MIB Master Information Block
MMEMobility Management Entity
MSC Mobile Switching Center
NPDCCH Narrowband Physical Downlink Control Channel
NR New Radio
OCNG OFDMA Channel Noise Generator
OFDM Orthogonal Frequency Division Multiplexing
OFDMA Orthogonal Frequency Division Multiple Access
OSS Operations Support System
OTDOA Observed Time Difference of Arrival
O&M Operation and Maintenance
PBCH Physical Broadcast Channel
P-CCPCH Primary Common Control Physical Channel
PCell Primary Cell
PCFICH Physical Control Format Indicator Channel
PDCCH Physical Downlink Control Channel
PDP Profile Delay Profile
PDSCH Physical Downlink Shared Channel
PGW Packet Gateway
PHICH Physical Hybrid-ARQ Indicator Channel
PLMN Public Land Mobile Network
PMI Precoder Matrix Indicator
PRACH Physical Random Access Channel
PRS Positioning Reference Signal
PSS Primary Synchronization Signal
PUCCH Physical Uplink Control Channel
PUSCH Physical Uplink Shared Channel
RACH Random Access Channel
QAM Quadrature Amplitude Modulation
RAN Radio Access Network
RAT Radio Access Technology
RLM Radio Link Management
RNC Radio Network Controller
RNTI Radio Network Temporary Identifier
RRC Radio Resource Control
RRM Radio Resource Management
RS Reference Signal
RSCP Received Signal Code Power
RSRP Reference Symbol Received Power OR
Reference Signal Received Power
RSRQ Reference Signal Received Quality OR
Reference Symbol Received Quality
RSSI Received Signal Strength Indicator
RSTD Reference Signal Time Difference
SCH Synchronization Channel
SCell Secondary Cell
SDU Service Data Unit
SFN System Frame Number
SGW Serving Gateway
SI System Information
SIB System Information Block
SNR Signal to Noise Ratio
SON Self Optimized Network
SS Synchronization Signal
SSS Secondary Synchronization Signal
TDD Time Division Duplex
TDOA Time Difference of Arrival
TOA Time of Arrival
TSS Tertiary Synchronization Signal
TTI Transmission Time Interval
UE User Equipment
UL Uplink
UMTS Universal Mobile Telecommunication System
USIM Universal Subscriber Identity Module
UTDOA Uplink Time Difference of Arrival
UTRA Universal Terrestrial Radio Access
UTRAN Universal Terrestrial Radio Access Network
WCDMA Wideband CDMA
WLAN Wireless Local Area Network

1. A method performed by a transmitting device, the method comprising at least one of:
Receiving an indication of an aggregation of N reference signal (RS) resources, the N RS resources each comprising a number of RS ports P1 and being selected from a group of M RS resources, N being at least 1, and M being at least 2;
Determining a number of RS ports, P2, as a number of RS ports in the aggregation of RS resources, according to the indication of the aggregation of N RS resources, where P2 is greater than or equal to P1;
Receiving an indication of a precoder to be applied to a physical channel, optionally, the precoder being for use in a P2 port transmission of the physical channel; and
transmitting the physical channel using the indicated precoder

2. The method of claim 1, further comprising determining the precoder and at least one of P2 and N from a single field in a control channel, the field comprising a predetermined number of bits, wherein the predetermined number of bits does not vary with the indicated precoder, nor does it vary if the indicated values of P2 or N vary.

3. The method of claim 2, further comprising at least one of:
determining a number of MIMO layers with which to transmit the physical channel using the field; and
transmitting the physical channel using the number of MIMO layers as well as the indicated precoder.

4. The method of any of the previous claims, further comprising:
providing user data; and
forwarding the user data to a host computer via the transmission to the base station.

5. A method performed by a transmitting device, the method comprising at least one of:
Receiving an indication of an aggregation of N reference signal (RS) resources, the N RS resources each comprising a number of RS ports P1 and being selected from a group of M RS resources, N being at least 1, and M being at least 2;
Determining a number of RS ports, P2, as a number of RS ports in the aggregation of RS resources, according to the indication of the aggregation of N RS resources, where P2 is greater than or equal to P1;
Receiving an indication of a precoder to be applied to a physical channel, the precoder being for use in a P2 port transmission of the physical channel; and
Transmitting the physical channel using the indicated precoder.

6. The method of claim 1, further comprising determining the number of layers in the plurality of MIMO layers as one of P2 and a sum of a plurality of rank indications, wherein each rank indication of the sum of rank indications corresponds to each of the N RS resources.

7. The method of any of the previous claims, further comprising:
providing user data; and
forwarding the user data to a host computer via the transmission to the base station.

8. A method performed wherein the transmitting device is either a wireless device such as a user equipment or network node such as a base station.

9. The method of any of the preceding claims, further comprising:
obtaining user data; and
forwarding the user data to a host computer or a wireless device.

10. A the wireless device comprising:
processing circuitry configured to perform any of the steps of any of the preceding claims; and
power supply circuitry configured to supply power to the wireless device.

11. A base station comprising:
processing circuitry configured to perform any of the steps of any of the claims 1-9;
power supply circuitry configured to supply power to the wireless device.

12. A user equipment (UE) comprising:
an antenna configured to send and receive wireless signals;
radio front-end circuitry connected to the antenna and to processing circuitry, and configured to condition signals communicated between the antenna and the processing circuitry;
the processing circuitry being configured to perform any of the steps of any of the claims 1-4;
an input interface connected to the processing circuitry and configured to allow input of information into the UE to be processed by the processing circuitry;
an output interface connected to the processing circuitry and configured to output information from the UE that has been processed by the processing circuitry; and
a battery connected to the processing circuitry and configured to supply power to the UE.

13. A communication system including a host computer comprising:
processing circuitry configured to provide user data; and
a communication interface configured to forward the user data to a cellular network for transmission to a user equipment (UE),
wherein the cellular network comprises a base station having a radio interface and processing circuitry, the base station's processing circuitry configured to perform any of the steps of any of the claims 6-9.

14. The communication system of the pervious claim further including the base station.

15. The communication system of the previous 2 claims, further including the UE, wherein the UE is configured to communicate with the base station.

16. The communication system of the previous 3 claims, wherein:
the processing circuitry of the host computer is configured to execute a host application, thereby providing the user data; and
the UE comprises processing circuitry configured to execute a client application associated with the host application.

17. A method implemented in a communication system including a host computer, a base station and a user equipment (UE), the method comprising:
at the host computer, providing user data; and
at the host computer, initiating a transmission carrying the user data to the UE via a cellular network comprising the base station, wherein the base station performs any of the steps of any of the claims 5-7.

18. The method of the previous claim, further comprising, at the base station, transmitting the user data.

19. The method of the previous 2 claims, wherein the user data is provided at the host computer by executing a host application, the method further comprising, at the UE, executing a client application associated with the host application.

20. A user equipment (UE) configured to communicate with a base station, the UE comprising a radio interface and processing circuitry configured to performs the of the previous 3 claims.

21. A communication system including a host computer comprising:
processing circuitry configured to provide user data; and
a communication interface configured to forward user data to a cellular network for transmission to a user equipment (UE),
wherein the UE comprises a radio interface and processing circuitry, the UE's components configured to perform any of the steps of any of the claims 1-4.

22. The communication system of the previous claim, wherein the cellular network further includes a base station configured to communicate with the UE.

23. The communication system of the previous 2 claims, wherein:
the processing circuitry of the host computer is configured to execute a host application, thereby providing the user data; and
the UE's processing circuitry is configured to execute a client application associated with the host application.

24. A method implemented in a communication system including a host computer, a base station and a user equipment (UE), the method comprising:
at the host computer, providing user data; and
at the host computer, initiating a transmission carrying the user data to the UE via a cellular network comprising the base station, wherein the UE performs any of the steps of any of the claims 1-4.

25. The method of the previous claim, further comprising at the UE, receiving the user data from the base station.

26. A communication system including a host computer comprising:
communication interface configured to receive user data originating from a transmission from a user equipment (UE) to a base station,
wherein the UE comprises a radio interface and processing circuitry, the UE's processing circuitry configured to perform any of the steps of any of claims 1-4.

27. The communication system of the previous claim, further including the UE.

28. The communication system of the previous 2 claims, further including the base station, wherein the base station comprises a radio interface configured to communicate with the UE and a communication interface configured to forward to the host computer the user data carried by a transmission from the UE to the base station.

29. The communication system of the previous 3 claims, wherein:
the processing circuitry of the host computer is configured to execute a host application; and
the UE's processing circuitry is configured to execute a client application associated with the host application, thereby providing the user data.

30. The communication system of the previous 4 claims, wherein:
the processing circuitry of the host computer is configured to execute a host application, thereby providing request data; and
the UE's processing circuitry is configured to execute a client application associated with the host application, thereby providing the user data in response to the request data.

31. A method implemented in a communication system including a host computer, a base station and a user equipment (UE), the method comprising: at the host computer, receiving user data transmitted to the base station from the UE, wherein the UE performs any of the steps of any of the claims 1-4.

32. The method of the previous claim, further comprising, at the UE, providing the user data to the base station.

33. The method of the previous 2 claims, further comprising:
at the UE, executing a client application, thereby providing the user data to be transmitted; and
at the host computer, executing a host application associated with the client application.

34. The method of the previous 3 claims, further comprising:
at the UE, executing a client application; and
at the UE, receiving input data to the client application, the input data being provided at the host computer by executing a host application associated with the client application,
wherein the user data to be transmitted is provided by the client application in response to the input data.

35. A communication system including a host computer comprising a communication interface configured to receive user data originating from a transmission from a user equipment (UE) to a base station, wherein the base station comprises a radio interface and processing circuitry, the base station's processing circuitry configured to perform any of the steps of any of the Group B claims.

36. The communication system of the previous claim further including the base station.

37. The communication system of the previous 2 claims, further including the UE, wherein the UE is configured to communicate with the base station.

38. The communication system of the previous 3 claims, wherein:
the processing circuitry of the host computer is configured to execute a host application;
the UE is configured to execute a client application associated with the host application, thereby providing the user data to be received by the host computer.

39. A method implemented in a communication system including a host computer, a base station and a user equipment (UE), the method comprising: at the host computer, receiving, from the base station, user data originating from a transmission which the base station has received from the UE, wherein the UE performs any of the steps of any of the claims 1-4.

40. The method of the previous claim, further comprising at the base station, receiving the user data from the UE.

41. The method of the previous 2 claims, further comprising at the base station, initiating a transmission of the received user data to the host computer.
